(19) United States
(12) Patent Application Publication
(10) Pub. No.: US 2025/0008497 A1
(43) Pub. Date: Jan. 2, 2025

(54) METHOD FOR CONFIGURING RESOURCES, TERMINAL, AND NETWORK DEVICE

(71) Applicant: GUANGDONG OPPO MOBILE TELECOMMUNICATIONS CORP., LTD., Dongguan (CN)

(72) Inventor: Shengjiang CUI, Dongguan (CN)

(21) Appl. No.: 18/882,230

(22) Filed: Sep. 11, 2024

Related U.S. Application Data
(63) Continuation of application No. PCT/CN2022/080482, filed on Mar. 11, 2022.

(51) Int. Cl. H04W 72/0446; H04W 72/1263; H04W 72/20

(52) U.S. Cl. CPC H04W 72/0446; H04W 72/1263; H04W 72/20

(57) ABSTRACT

A method for configuring resources, a terminal, and a network device are provided. The method includes: receiving, by a terminal, first information sent by a network device, where the first information is used for configuring, for the terminal, a time domain resource used for backscatter communication. The network device may configure or schedule, for the terminal by using the first information, the time domain resource used for backscatter communication. In other words, the network device implements, by using the first information, allocation and control of the time domain resource that can be used for backscatter communication.

### CROSS-REFERENCE TO RELATED APPLICATIONS

This application is a continuation of International Application No. PCT/CN2022/080482, filed on Mar. 11, 2022, the disclosure of which is hereby incorporated by reference in its entirety.

### TECHNICAL FIELD

This application relates to the field of communications technologies, and more specifically, to a method for configuring resources, a terminal, and a network device.

### BACKGROUND

Backscatter communication is an important technology used for communication of zero-power-consumption devices. In related technologies, when performing backscatter communication, a terminal arbitrarily determines a backscatter communication resource. This may cause many problems. In one aspect, different terminals may use a same resource to perform backscatter communication, which causes collision and interference in backscatter communication of different terminals. This case is especially prominent when a large quantity of terminal devices perform backscatter communication. In another aspect, a network device needs to constantly monitor backscatter communication. This may not only cause waste of resources, but also result in low efficiency of backscatter communication.

### SUMMARY

This application provides a method for configuring resources, a terminal, and a network device, to resolve a problem resulted from that a terminal device arbitrarily determines a resource in a backscatter communication process.

According to a first aspect, a method for configuring resources is provided. The method includes: receiving, by a terminal, first information sent by a network device, where the first information is used for configuring, for the terminal, a time domain resource used for backscatter communication.

According to a second aspect, a method for configuring resources is provided. The method includes: sending, by a network device, first information to a terminal, where the first information is used for configuring, for the terminal, a time domain resource used for backscatter communication.

According to a third aspect, a terminal is provided. The terminal includes: a first receiving unit, configured to receive first information sent by a network device, where the first information is used for configuring, for the terminal, a time domain resource used for backscatter communication.

According to a fourth aspect, a network device is provided. The network device includes: a first sending unit, configured to send first information to a terminal, where the first information is used for configuring, for the terminal, a time domain resource used for backscatter communication.

According to a fifth aspect, a terminal device is provided, including a processor, a memory, and a communications interface. The memory is configured to store one or more computer programs. The processor is configured to invoke the computer programs in the memory, to cause the terminal device to perform the method in the first aspect.

According to a sixth aspect, a network device is provided, including a processor, a memory, and a communications interface. The memory is configured to store one or more computer programs. The processor is configured to invoke the computer programs in the memory, to cause the network device to perform the method in the second aspect.

According to a seventh aspect, an embodiment of this application provides a communications system. The system includes the foregoing terminal device and/or network device. In another possible design, the system may further include another device interacting with the terminal or the network device in the solutions provided in embodiments of this application.

According to an eighth aspect, an embodiment of this application provides a computer-readable storage medium. The computer-readable storage medium stores a computer program. The computer program causes a terminal device to perform some or all of the steps in the method in the first aspect.

According to a ninth aspect, an embodiment of this application provides a computer-readable storage medium. The computer-readable storage medium stores a computer program. The computer program causes a network device to perform some or all of the steps in the method in the second aspect.

According to a tenth aspect, an embodiment of this application provides a computer program product. The computer program product includes a non-transitory computer-readable storage medium that stores a computer program. The computer program is operable to cause a terminal to perform some or all of the steps in the method in the first aspect. In some implementations, the computer program product may be a software installation package.

According to an eleventh aspect, an embodiment of this application provides a computer program product. The computer program product includes a non-transitory computer-readable storage medium that stores a computer program. The computer program is operable to cause a network device to perform some or all of the steps in the method in the second aspect. In some implementations, the computer program product may be a software installation package.

According to a twelfth aspect, an embodiment of this application provides a chip. The chip includes a memory and a processor. The processor may invoke and run a computer program from the memory, to implement some or all of the steps described in the method in the first aspect or the second aspect.

According to a thirteenth aspect, a computer program product is provided, and the computer program product includes a program that causes a computer to perform the method in the first aspect.

According to a fourteenth aspect, a computer program product is provided, and the computer program product includes a program that causes a computer to perform the method in the second aspect.

According to a fifteenth aspect, a computer program is provided. The computer program causes a computer to perform the method in the first aspect.

According to a sixteenth aspect, a computer program is provided. The computer program causes a computer to perform the method in the second aspect.

A network device may configure or schedule, for a terminal by using first information, a time domain resource used for backscatter communication. In other words, the network device implements, by using the first information, allocation and control of the time domain resource that can be used for backscatter communication.

### BRIEF DESCRIPTION OF DRAWINGS

FIG. 1 shows a wireless communications system to which an embodiment of this application is applied.

FIG. 2 shows a possible structure of an energy collection module.

FIG. 3 shows a backscatter communication principle according to an embodiment of this application.

FIG. 4 is a circuit diagram of a terminal based on a resistor load modulation technology.

FIG. 5 is a schematic flowchart of a communication method according to an embodiment of this application.

FIG. 6 is a diagram of an example of a first time domain resource set according to an embodiment of this application.

FIG. 7 is a diagram of an example of a first time domain resource set according to another embodiment of this application.

FIG. 8 is a diagram of an example of a first time domain resource set according to another embodiment of this application.

FIG. 9 is a diagram of an example of a first time domain resource set according to another embodiment of this application.

FIG. 10 is a diagram of an example of a first time domain resource set according to another embodiment of this application.

FIG. 11 is a diagram of an example of a first time domain resource set according to another embodiment of this application.

FIG. 12 is a diagram of an example of a first time domain resource set according to another embodiment of this application.

FIG. 13 is a diagram of an example indicating a resource mapping pattern according to an embodiment of this application.

FIG. 14 is a diagram of an example indicating a resource mapping pattern according to another embodiment of this application.

FIG. 15 is a diagram of an example indicating a resource mapping pattern according to another embodiment of this application.

FIG. 16 is a diagram of an example indicating a resource mapping pattern according to another embodiment of this application.

FIG. 17 is a diagram of an example indicating a resource mapping pattern according to another embodiment of this application.

FIG. 18 is a diagram of an example indicating a resource mapping pattern according to another embodiment of this application.

FIG. 19 is a diagram of an example indicating a resource mapping pattern according to another embodiment of this application.

FIG. 20 is a diagram of an example indicating a resource mapping pattern according to another embodiment of this application.

FIG. 21 is a diagram of an example of a first time domain resource set that meets a first rule according to an embodiment of this application.

FIG. 22 is a diagram of an example of a plurality of resource mapping patterns according to an embodiment of this application.

FIG. 23 is a diagram of an example of periodically switching between resource mapping patterns according to an embodiment of this application.

FIG. 24 is a diagram of an example indicating a resource mapping pattern according to another embodiment of this application.

FIG. 25 is a diagram of an example indicating a resource mapping pattern according to another embodiment of this application.

FIG. 26 is a diagram of an example indicating a resource mapping pattern according to another embodiment of this application.

FIG. 27 is a diagram of an example indicating a resource mapping pattern according to another embodiment of this application.

FIG. 28 is a diagram of an example indicating a resource mapping pattern according to another embodiment of this application.

FIG. 29 is a diagram of an example indicating a resource mapping pattern according to another embodiment of this application.

FIG. 30 is a diagram of an example indicating a resource mapping pattern according to another embodiment of this application.

FIG. 31 is a diagram of an example indicating a resource mapping pattern according to another embodiment of this application.

FIG. 32 is a diagram of an example indicating a resource mapping pattern according to another embodiment of this application.

FIG. 33 is a diagram of an example indicating a resource mapping pattern according to another embodiment of this application.

FIG. 34 is a diagram of an example indicating a resource mapping pattern according to another embodiment of this application.

FIG. 35 is a schematic diagram of a structure of a terminal according to an embodiment of this application.

FIG. 36 is a schematic diagram of a structure of a network device according to an embodiment of this application.

FIG. 37 is a schematic diagram of a structure of an apparatus according to an embodiment of this application.

### DESCRIPTION OF EMBODIMENTS

The following describes technical solutions of this application with reference to the accompanying drawings.

With development of wireless communications technologies, it is expected to integrate a wireless communications system with various vertical industries such as logistics, manufacturing, transportation, and energy. For example, the wireless communications system may be integrated with an industrial wireless sensor network (IWSN). For another example, the wireless communications system may be integrated with smart logistics and smart warehousing. For another example, the wireless communications system may be integrated with a smart home network.

However, in these industries, a terminal usually needs to have features such as relatively low costs, a relatively small size (for example, ultra-thin), maintenance-free, and a long life. Therefore, to meet the foregoing condition, communication may be performed between a network device and a terminal by using a zero-power-consumption communications technology. In this case, the terminal may also be referred to as a “zero-power-consumption communications terminal”.

For example, as industry application of a fifth-generation (5G) communications system increases, there are more types of connection objects and more application scenarios. Higher requirements are imposed on a price and power consumption of a communications terminal. Application of battery-free and low-cost passive Internet of things devices become key technologies of cellular Internet of things. The passive Internet of things device may enrich types and a quantity of 5G network linked terminals, to implement the Internet of everything. The passive Internet of things device may be implemented based on a zero-power-consumption device. Alternatively, the passive Internet of things device may extend based on a zero-power-consumption device, to adapt to the cellular Internet of things.

A typical zero-power-consumption communications technology may be, for example, a radio frequency identification (RFID) technology. The RFID technology is a technology that implements contactless automatic transmission and identification of tag information in a manner of spatial coupling of radio frequency signals.

A basic RFID system may be composed of an electronic tag (tag) and a reader/writer (reader/writer). The electronic label may be composed of a coupling component and a chip. Each electronic label has a unique electronic code that is placed on a target to mark a target object. The electronic tag may also be referred to as a radio frequency tag or an RFID tag. The reader/writer may read information of the electronic label, may further write information for the electronic label, and may also provide communication-required energy for the electronic label. For example, the electronic label comes near the reader/writer, and may receive a radio frequency signal sent by the reader/writer. The electronic label may transmit, by using energy obtained through an electromagnetic field generated in space, information stored in the electronic label. The reader/writer may read and decode the information to identify the electronic tag.

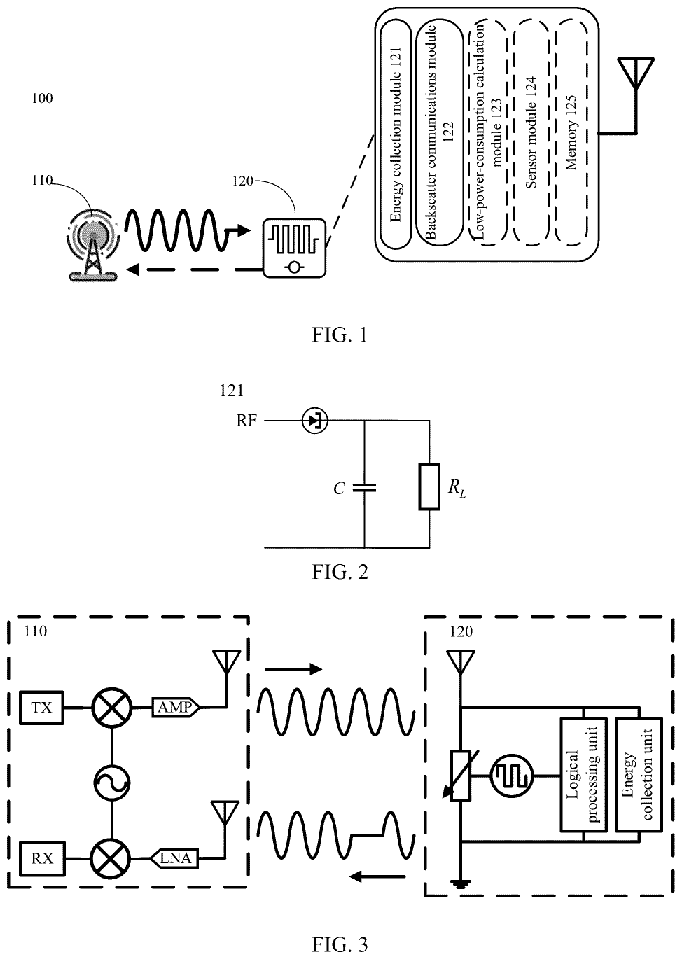

The following describes the zero-power-consumption communication technology and the zero-power-consumption terminal with reference to FIG. 1 to FIG. 4. FIG. 1 shows an architecture of a zero-power-consumption communications system 100 to which an embodiment of this application is applied. The architecture shown in FIG. 1 includes a network device 110 and a terminal 120. The network device 110 may be a device in communication with the terminal device 120. Each network device 110 may provide communication coverage for a specific geographic area, and may communicate with a terminal device 120 located within the coverage area. The network device 110 may be, for example, a reader/writer, and the terminal 120 may be, for example, an electronic tag.

The network device 110 is configured to send a wireless energy supply signal to the terminal 120 to supply energy to the terminal. Correspondingly, the terminal 120 may send data to the network device 110 by using a backscatter signal. In some implementations, the foregoing wireless energy supply signal may further carry data or control information sent by the network device 110 to the terminal 120. Certainly, the foregoing wireless energy supply signal may be used only for energy supply. This is not limited in embodiments of this application.

It should be noted that FIG. 1 exemplarily shows one network device and one terminal. Optionally, the communications system 100 may include a plurality of network devices, and another quantity of terminal devices may be included in coverage of each network device. This is not limited in embodiments of this application.

In addition, in some implementations, the communications system 100 may further include other network entities such as a network controller and a mobility management entity. This is not limited in embodiments of this application.

It should be understood that technical solutions of embodiments of this application may be applied to various communications systems, such as a 5G system or a new radio (NR) system, a long term evolution (LTE) system, an LTE frequency division duplex (FDD) system, LTE time division duplex (TDD), and a cellular Internet of things. The technical solutions provided in this application may be further applied to a future communications system, such as a sixth generation mobile communications system.

The terminal in embodiments of this application may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal device, a wireless communications device, a user agent, or a user apparatus. The terminal device in embodiments of this application may refer to a device that provides voice and/or data connectivity for a user, and may be configured to connect a person, an object, and a machine, for example, a household appliance with a wireless connection function, a sensor, and an electronic tag. The terminal in embodiments of this application may be a wireless terminal in a smart home (smart home), a wireless terminal in an IWSN, a wireless terminal in smart logistics and smart warehousing, a wireless terminal in self driving (self driving), a wireless terminal in a remote medical surgery (remote medical surgery), a wireless terminal in a smart grid (smart grid), a wireless terminal in transportation safety (transportation safety), a wireless terminal in a smart city (smart city), or the like.

The network device in embodiments of this application may be a device configured to communicate with the terminal device. If the terminal is an electronic label, the network device may be a reader/writer (for example, a reader/writer based on a radio frequency identification (RFID) technology) that is configured to read from and/or write into the electronic label. The network device may be alternatively an access network device or a radio access network device. For example, the network device may be a base station. The network device in embodiments of this application may refer to a radio access network (RAN) node (or device) that connects the terminal device to a wireless network. The base station may broadly cover various names as below, or may be replaced with the following names, such as a NodeB (NodeB), an evolved NodeB (eNB), a next generation NodeB (gNB), a relay station, an access point, a transmitting and receiving point (TRP), a transmitting point (TP), a master MeNB, a secondary SeNB, a multi-standard radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof. Alternatively, the base station may refer to a communications module, a modem, or a chip disposed in the device or apparatus described above. Alternatively, the base station may be a mobile switching center, a device that functions as a base station in device to device D2D, vehicle-to-everything (V2X), and machine-to-machine (M2M) communication, a network-side device in a 6G network, a device that functions as a base station in a future communications system, or the like. The base station may support networks of the same or different access technologies. A specific technology and a specific device form used by the network device are not limited in embodiments of this application.

The base station may be fixed or mobile. For example, a helicopter or an unmanned aerial vehicle may be configured to serve as a mobile base station, and one or more cells may move according to a location of the mobile base station. In another example, a helicopter or an unmanned aerial vehicle may be configured to serve as a device in communication with another base station.

In some deployments, the network device in embodiments of this application may refer to a CU or a DU, or the network device includes a CU and a DU. The gNB may further include an AAU.

The network device and the terminal device may be deployed on land, including being indoors or outdoors, handheld, or vehicle-mounted; may be deployed on a water surface; or may be deployed on a plane, a balloon, or a satellite in the air. In embodiments of this application, a scenario in which the network device and the terminal device are located is not limited.

It should be understood that all or some of functions of the communications device in this application may also be implemented by software functions running on hardware, or by virtualization functions instantiated on a platform (for example, a cloud platform).

For ease of understanding of the zero-power-consumption communications technology, the following describes a terminal that supports the zero-power-consumption communications technology with reference to FIG. 2.

Usually, the terminal 120 may include an energy collection module 121 and a backscatter communications module 122. The following describes the energy collection module 121 and the backscatter communications module 122 with reference to FIG. 2 to FIG. 4. For brevity, details are not described herein again. In some cases, the terminal 120 may further include a low-power-consumption calculation module 123. The low-power-consumption calculation module 123 is configured to provide a calculation function, such as data processing, for the terminal. In some other cases, the terminal 120 may further include a sensor 124 configured to collect external information (for example, ambient temperature and ambient humidity). In some other cases, the terminal 120 may further include a memory 125 configured to store some information (for example, external information collected by using the foregoing sensor, or an object identifier). The terminal 120 may transmit, to the network device by using a zero-power-consumption mechanism, information stored or data collected by various sensors.

The energy collection module 121 is configured to collect energy. In some implementations, energy may be collected by using a wireless energy supply signal sent by the network device. The wireless energy supply signal may be a “radio frequency signal” sent by the network device. Therefore, the foregoing energy collection module is also referred to as a “radio frequency energy collection module”.

FIG. 2 shows a possible structure of an energy collection module. As shown in FIG. 2, the energy collection module 121 may collect energy of a spatial electromagnetic wave of a radio frequency signal based on an electromagnetic induction principle, and store the collected energy in a capacitor C, that is, a charging process of the capacitor C. After the charging process of the capacitor C ends, the capacitor C may start to discharge to supply energy for the terminal to work. For example, the discharge of the capacitor C may be utilized to drive the terminal to perform low-power-consumption demodulation on data sent by the network device. For another example, the discharge of the capacitor C discharges may be utilized to drive the terminal to perform modulation on to-be-sent data. For another example, the discharge of the capacitor C may be utilized to drive a sensor of the terminal to perform data collection. For another example, the discharge of the capacitor C may be utilized to drive, the terminal to read data in the memory 125.

The foregoing backscatter communications module 122 is used by the terminal to perform backscatter communication (back scattering) with the network device. The following describes the backscatter communication principle according to an embodiment of this application with reference to FIG. 3. With reference to FIG. 3, the terminal 120 receives a carrier signal sent by the network device 110. The terminal 120 may collect energy by using an energy collection unit. The energy collection unit may be, for example, a radio frequency (RF) energy collection unit. The energy collection unit may supply energy to the low-power-consumption calculation module 123 (for example, a logical processing unit shown in FIG. 3). The terminal 120 may modulate an incoming wave and perform backscatter.

Main features of backscatter communication include:

(1) The terminal does not actively transmit a signal, and implements backscatter communication by modulating an incoming-wave signal.

(2) The terminal is independent of a conventional active power amplification transmitter, and uses a low-power-consumption calculation unit, which greatly reduces hardware complexity.

(3) With energy collection, the terminal can implement battery-free communication.

In some implementations, another component may be further disposed on a transport (TX) path of the network device 110, and is configured to process a to-be-sent signal, for example, an amplifier (AMP). Another component may be further disposed on a receive (RX) path of the network device 110, to process a received signal, for example, a low noise amplifier (LNA).

In some other implementations, the energy collection unit may be disposed in the terminal 120, and is configured to collect energy of a wireless energy supply signal sent by the network device. Certainly, the logical processing unit may be further disposed in the terminal 120, to execute a corresponding calculation function.

It should be noted that, for both the network device 110 and the terminal 120, FIG. 3 shows only an example of a connection structure of a signal processing circuit, and processing circuits of the network device 110 and/or the terminal 120 may include other elements. This is not specifically limited in this embodiment of this application.

In load modulation, an electrical parameter of an oscillation circuit of an electronic tag is adjusted according to a beat of a data stream, so that an amplitude and a phase of impedance of the electronic tag change accordingly, thereby completing a modulation process. A load modulation function may be implemented in two manners: resistor load modulation and capacitor load modulation. In resistor load modulation, a load may be connected in parallel to a resistor, and the resistor may be referred to as a load modulation resistor.

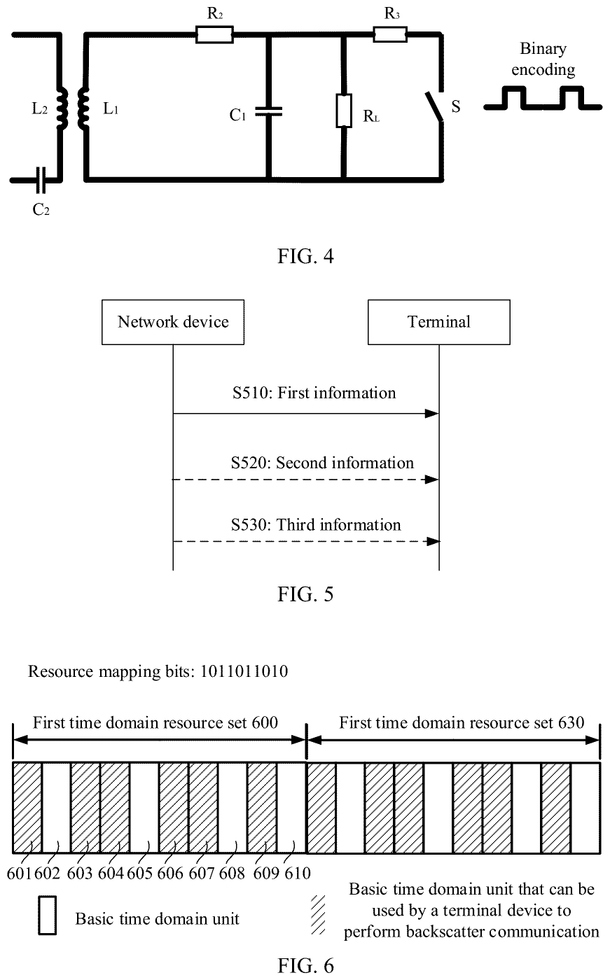

FIG. 4 is a circuit diagram of a terminal based on a resistor load modulation technology. It should be noted that an implementation of a circuit depicted in FIG. 4 that implements a load modulation technology is similar to an existing implementation of a circuit implementing a load modulation technology. For brevity, details of functions of resistors R₂ and R₃, capacitors C₁ and C₂, and inductors L₁ and L₂ included in the circuit in FIG. 4 are not described.

In resistor load modulation, a load modulation resistor R_{L} may be connected in parallel to a load. A switch S may implement on/off of the resistor R_{L} under the control of a binary data stream. In this way, on/off of the resistor R_{L} may cause a change of a circuit voltage, and the change of the circuit voltage may in turn control an amplitude of a backscatter signal of the terminal, to implement modulation of the backscatter signal. In other words, amplitude-shift keying (ASK) modulation is performed on the backscatter signal.

Similarly, in capacitor load modulation, on/off of a capacitor may be controlled based on a binary data stream, to change a circuit resonance frequency and further change an operating frequency of a backscatter signal. In this way, frequency-shift keying (FSK) modulation is implemented.

Data transmitted by an encoding end (for example, a terminal or an electronic tag) may employ different encoding manners to denote binary “1” and “0”. Correspondingly, a decoding end (for example, a network device or a radio frequency identification system) may decode, in a corresponding decoding manner, a bit stream sent by the encoding end. Commonly-used encoding methods in zero-power-consumption communications technologies include: non-return-to-zero (NRZ) encoding, Manchester (manchester) encoding, unipolar return-to-zero (unipolar RZ) encoding, differential binary phase (DBP) encoding, Miller (miller) encoding, differential encoding, and the like.

A signal in a zero-power-consumption communications system may include an energy supply signal and a trigger signal.

A carrier of the energy supply signal may be a base station, a smartphone, a smart gateway, a charging station, a micro base station, or the like. A radio wave of the energy supply signal may be a low-frequency wave, a medium-frequency wave, a high-frequency wave, or the like. A waveform of the radio wave of the energy supply signal may be a sine wave, a square wave, a triangular wave, a pulse, a rectangular wave, or the like. The radio wave of the energy supply signal may be a continuous wave, or may be a discontinuous wave (that is, a waveform that allows an interruption of a specific time). The energy supply signal may be a signal specified in a related communications standard or a newly defined signal. For example, the energy supply signal is a signal specified in the 3GPP standard. In an implementation, the energy supply signal may include a sounding reference signal (SRS), a physical uplink shared channel (PUSCH), a physical random access channel (PRACH), a physical uplink control channel (PUCCH), a physical downlink control channel (PDCCH), a physical downlink shared channel (PDSCH), a physical broadcast channel (PBCH), and the like.

A carrier of the trigger signal may be a base station, a smartphone, a smart gateway, or the like. A radio wave of the trigger signal may be a low-frequency wave, a medium-frequency wave, a high-frequency wave, or the like. The radio wave of the trigger signal may be a sine wave, a square wave, a triangular wave, a pulse, a rectangular wave, or the like. The radio wave of the trigger signal may be a continuous wave, or may be a discontinuous wave. The trigger signal may be a signal specified in a related communications standard or a newly defined signal. For example, the trigger signal is a signal specified in the 3GPP standard. In an implementation, the trigger signal may include an SRS, a PUSCH, a PRACH, a PUCCH, a PDCCH, a PDSCH, a PBCH, or the like.

Based on the foregoing descriptions of the zero-power-consumption communications technology, it may be learned that a terminal (also referred to as a “zero-power-consumption terminal”) in zero-power-consumption communication consumes little energy of the terminal for communication, and may even not consume energy of the terminal. Therefore, in the zero-power-consumption communications technology, the terminal may be classified, based on an energy source and an energy use manner of the terminal, into three types: a passive zero-power-consumption terminal, a semi-passive zero-power-consumption terminal, and an active zero-power-consumption terminal.

### 1. Passive Zero-Power-Consumption Terminal

A battery usually does not need to be installed on the passive zero-power-consumption terminal. When the terminal approaches the network device, the terminal is within a near-field range formed by radiation of an antenna of the network device. In this case, an antenna of the terminal may generate an induced current through electromagnetic induction. The induced current may supply energy to the terminal, to implement demodulation of a received signal, modulation and encoding of a to-be-transmitted signal, and/or the like. In some implementations, the foregoing passive zero-power-consumption terminal may be an electronic tag. Correspondingly, the network device may be a reader/writer of an RFID system. The reader/writer is configured to read content in the electronic tag and/or is configured to change content in the electronic tag.

It may be understood that the passive zero-power-consumption terminal does not need an internally installed battery to drive either a forward link or a reverse link, and is a zero-power-consumption terminal in a true sense.

### 2. Semi-Passive Zero-Power-Consumption Terminal

A conventional battery is not installed on the semi-passive zero-power-consumption terminal. The semi-passive zero-power-consumption terminal may collect radio wave energy by using an energy collection module 121, and store the collected energy in an energy storage unit (such as a capacitor). After obtaining energy, the energy storage unit may supply energy to the terminal, to implement demodulation of a received signal, modulation and encoding of a to-be-transmitted signal, and/or the like.

It may be understood that the semi-passive zero-power-consumption terminal does not need an internally installed battery to drive either a forward link or a reverse link. Although energy stored in a capacitor is used during operation, energy comes from radio energy collected by the energy collection module. Therefore, the semi-passive zero-power-consumption terminal is also a zero-power-consumption terminal in a true sense.

### 3. Active Zero-Power-Consumption Terminal

A battery may be internally installed on the active zero-power-consumption terminal. The battery may supply energy to the terminal to implement demodulation of a received signal, modulation and encoding of a to-be-transmitted signal, and/or the like. However, when the terminal device performs communication by using a backscatter technology, the terminal does not need to consume energy of the battery. Therefore, for such a terminal, “zero power consumption” is mainly reflected in a scenario in which the terminal performs communication by using the backscatter technology.

In some implementations, the foregoing active zero-power-consumption terminal may be an electronic tag, and the network device may be an RFID reader/writer. In this case, the internally installed battery may supply power to an RFID chip in the terminal, to increase a read/write distance between the RFID reader and the electronic tag. In addition, the internally installed battery may supply power to the RFID chip in the terminal, to shorten a read/write delay of the RFID reader/writer for the electronic tag, thereby facilitating an improvement in communication reliability.

In related technologies, when performing backscatter communication, the terminal arbitrarily determines a backscatter communication resource. This may cause many problems. In one aspect, different terminals may use a same resource to perform backscatter communication, which causes collision and interference in backscatter communication of different terminals. This case is especially prominent when a large quantity of terminal devices perform backscatter communication. In another aspect, the network device needs to constantly monitor backscatter communication. This may not only cause waste of resources, but also result in low efficiency of backscatter communication.

FIG. 5 is a schematic flowchart of a communication method according to an embodiment of this application, to resolve the foregoing problem. The communication method shown in FIG. 5 may be performed by a terminal and a network device.

It should be noted that the terminal to which this application is applicable may be a terminal that supports backscatter communication. For example, the terminal may be a zero-power-consumption device or a non-zero-power-consumption device. For example, the non-zero-power-consumption device may be a terminal that does not collect energy but supports backscatter communication. In some embodiments, the terminal may alternatively be a terminal that supports communication in some communications systems (for example, an NR system). For example, the terminal may be an NR terminal on which a backscatter communications module is mounted.

The method shown in FIG. 5 may include step S510. Step S510: The network device sends first information. Correspondingly, the terminal receives the first information.

The first information may be used for configuring, for the terminal, a time domain resource used for backscatter communication. It may be understood that the time domain resource that is used for backscatter communication and configured for the terminal by using the first information may be an occasion for backscatter communication. In other words, the terminal does not necessarily perform backscatter communication on all time domain resources configured by using the first information. The time domain resource used when the terminal actually performs backscatter communication may be a subset of the time domain resources configured by using the first information. In other words, the terminal may perform backscatter communication by using all the time domain resources configured by using the first information, or may perform backscatter communication by using some time domain resources configured by using the first information. For example, the terminal may determine an available time domain resource of the terminal based on the first information, and then determine and use some or all of available time domain resources to perform backscatter communication.

It may be understood that the network device may configure or schedule, for the terminal by using the first information, the time domain resource used for backscatter communication. In other words, the network device implements, by using the first information, allocation and control of the time domain resource that can be used for backscatter communication. For example, the network device may configure, for different terminals, different time domain resources used for backscatter communication, so that collision and interference in backscatter communication can be avoided between different terminals. Alternatively, the network device may monitor backscatter communication in an occasion corresponding to the configured time domain resource used for backscatter communication, so as to reduce resource waste and improve efficiency of backscatter communication.

The first information may be used to indicate a first resource mapping pattern. The first resource mapping pattern may be used for configuring, for the terminal, the time domain resource used for backscatter communication. In other words, by indicating the first resource mapping pattern, the first information may be used for configuring, for the terminal, the time domain resource used for backscatter communication.

This application does not limit a manner in which the first information indicates the first resource mapping pattern. For example, the first information may include specific content of the first resource mapping pattern, and the terminal may determine a backscatter communication resource based on the first resource mapping pattern in the first information. Alternatively, several resource mapping patterns (for example, agreed upon by using a communications protocol) may be agreed upon between the terminal and the network device, and the first information may include identification information (for example, an index) of the first resource mapping pattern. The terminal may determine the first resource mapping pattern from several resource mapping patterns based on the identification information in the first information, and further determine, based on the first resource mapping pattern, the time domain resource used for backscatter communication.

It may be understood that the first resource mapping pattern may be a resource mapping pattern used to indicate backscatter communication. In an implementation, the first resource mapping pattern may include at least one resource mapping bit. The resource mapping bit may be associated with a time domain resource. The resource mapping bit may indicate whether the time domain resource associated with the resource mapping bit can be used by the terminal to perform backscatter communication. For example, in a case that a value of the resource mapping bit is a first bit value, the terminal device can perform backscatter communication by using the time domain resource associated with the resource mapping bit; or in a case that a value of the resource mapping bit is a second bit value, the terminal device cannot perform backscatter communication by using the time domain resource associated with the resource mapping bit. The first bit value may be 0, and the second bit value may be 1. Alternatively, the first bit value may be 1, and the second bit value may be 0.

The time domain resource used for backscatter communication, which is configured for the terminal based on the first resource mapping pattern, may belong to a plurality of time domain resources. For example, the plurality of time domain resources may be all or a part of time domain resources that can be configured by the network device. The plurality of time domain resources may include at least one first time domain resource set. In other words, the time domain resource used for backscatter communication may belong to at least one first time domain resource set. The first time domain resource set may include a plurality of basic time domain units. For example, the plurality of time domain resources may be divided into a plurality of first time domain resource sets, so that backscatter resource configuration can be implemented by using the first time domain resource set as a granularity.

The first time domain resource set may include N basic time domain units, where N may be an integer greater than 0. Some or all basic time domain units in the first time domain resource set may be communication resources that can be used by the terminal to perform backscatter communication. The basic time domain unit may be a basic component of the first time domain resource set. For example, the first time domain resource set may be divided into a plurality of parts, and any part in the plurality of parts may be a basic time domain unit.

The first resource mapping pattern may be used to indicate a basic time domain unit, in at least one first time domain resource set, that can be used for the terminal to perform backscatter communication. In other words, the first resource mapping pattern may be associated with at least one first time domain resource set. For the first time domain resource set associated with the first resource mapping pattern, the first resource mapping pattern may be used to indicate a basic time domain unit, in the first time domain resource set, that can be used by the terminal to perform backscatter communication. In an implementation, the first resource mapping pattern may include at least one resource mapping bit, which may include a first resource mapping bit. The first time domain resource set may include a plurality of basic time domain units, which may include a first basic time domain unit. The first resource mapping bit may be associated with the first basic time domain unit.

A default resource mapping pattern may be used for a first time domain resource set that is not associated with the first resource mapping pattern. The default resource mapping pattern may be configured by the network device, or may be predefined. The network device may configure a plurality of resource mapping patterns. The terminal device may select one resource mapping pattern from the plurality of resource mapping patterns as the default resource mapping pattern. The default resource mapping pattern may be one of the plurality of resource mapping patterns, for example, may be the 1^{st} resource mapping pattern, the final resource mapping pattern, or a randomly selected one of the plurality of resource mapping patterns. Alternatively, a first time domain resource set that is not associated with the first resource mapping pattern may not include a resource that can be used for the terminal to perform backscatter communication.

The first time domain resource set may be understood as a period of time. A measurement manner of the first time domain resource set is not limited in this application.

For example, a length of the first time domain resource set may be measured by using absolute time. In some implementations, a unit of the first time domain resource set may be a microsecond (μm), a millisecond (ms), a second(s), or the like. Correspondingly, a length of the basic time domain unit may also be measured by using absolute time. For example, the unit of the first time domain resource set is ms. In this case, a time length of the first time domain resource set may be 0.5 ms. The first time domain resource set may include 10 basic time domain units. One basic time domain unit may be 0.05 ms.

Alternatively, a length of the first time domain resource set may be measured by using relative time. In some implementations, a unit of the first time domain resource may be a symbol, a slot, a subframe, or a frame as defined in some communications systems (for example, an NR system). For example, the basic time domain unit may be one or more OFDM symbols/slots/subframes/frames. Alternatively, a unit of the first time domain resource may be a backscatter communication basic unit. The backscatter communication basic unit may be a time unit defined for backscatter communication. Optionally, the backscatter communication basic unit may be a time domain resource used for sending 1-bit or 1-symbol information through backscattering. Alternatively, the backscatter communication basic unit may be a time domain resource used for sending a plurality of bits or symbols of information through backscattering. Alternatively, the backscatter communication basic unit may be a time domain resource corresponding to transmission of a fixed-size data packet through backscattering. For example, the unit of the first time domain resource set is a backscatter communication basic unit. In this case, a time length of the first time domain resource set may be 10 backscatter communication basic units. The first time domain resource set may include 10 basic time domain units. One basic time domain unit may be one backscatter communication basic unit.

FIG. 6 is a diagram of an example of a first time domain resource set according to an embodiment of this application. FIG. 6 shows a first time domain resource 600 and a first time domain resource set 630. The first time domain resource set 600 may include a basic time domain unit 601 to a basic time domain unit 610. The basic time domain units 601-610 may each be a backscatter communication basic unit. As shown in FIG. 6, the basic time domain unit 601, a basic time domain unit 603, a basic time domain unit 604, a basic time domain unit 606, a basic time domain unit 607, and a basic time domain unit 609 may be basic time domain units, in the first time domain resource set 600, that can be used by a terminal device to perform backscatter communication.

It may be understood that, in a case that a first resource mapping bit is associated with a first basic time domain unit, the first resource mapping bit may be used to indicate whether the first basic time domain unit can be used for the terminal to perform backscatter communication. For example, a value of the first resource mapping bit may be a first bit value or a second bit value. In a case that the first resource mapping bit has the first bit value, the first basic time domain unit may be used for backscatter communication. Alternatively, in a case that the first resource mapping bit has the second bit value, the first basic time domain unit is not used for backscatter communication.

The first resource mapping bit may be associated with a plurality of basic time domain units. For example, the first time domain resource set may further include another basic time domain unit. The first resource mapping bit may be associated with the first basic time domain unit and the another basic time domain unit. For example, in a case that the first resource mapping bit has the first bit value, both the first basic time domain unit and the another basic time domain unit may be used for backscatter communication. Alternatively, in a case that the first resource mapping bit has the second bit value, neither the first basic time domain unit nor the another basic time domain unit may be used for backscatter communication. For example, the first bit value may be 0 or 1, and correspondingly, the second bit value may be 1 or 0.

In at least one resource mapping bit, some resource mapping bits may be not associated with a basic time domain unit. For example, at least one resource mapping bit may include a second resource mapping bit, and the second resource mapping bit may be not associated with a basic time domain unit. In other words, a quantity of units of basic time domain units associated with the second resource mapping bit may be 0. In some embodiments, the second resource mapping bit may also be referred to as a reserved bit. The second resource mapping bit may be used to indicate other information. For example, the second resource mapping bit may be used to indicate a quantity of sets of first time domain resource sets associated with a first resource mapping pattern. Alternatively, the second resource mapping bit may be used to indicate an effective period, an effective duration, and an effective rule of the first resource mapping pattern, so that the first resource mapping pattern can indicate a plurality of first time domain resource sets.

A quantity of bits of reserved bits in the first resource mapping pattern is not limited in this application. For example, the first resource mapping pattern may include one or more reserved bits. The second resource mapping bit may be one or more of, or all of the plurality of reserved bits. A location of the reserved bit in the first resource mapping pattern is not limited in this application. For example, the reserved bit may be located at the beginning, middle, or end of the first resource mapping pattern. For example, the first resource mapping pattern includes four reserved bits. In this case, first four bits in the first resource mapping pattern may be reserved bits, or final four bits in the first resource mapping pattern may be reserved bits. For example, the reserved bit is represented by x. The first resource mapping pattern may be, for example, xxxx1011011010 or 1011011010xxxx.

With reference to FIG. 6 to FIG. 12, the following uses an example in which the first resource mapping pattern includes M resource mapping bits, and the first time domain resource set includes N basic time domain units, to describe a mapping relationship between the first resource mapping pattern and the first time domain resource set. The M resource mapping bits may be associated with the N basic time domain units. Herein, M may be an integer greater than 0, and N may be an integer greater than 0.

In a case that M is equal to N, the M resource mapping bits may be in one-to-one association with the N basic time domain units. In other words, each resource mapping bit may be used to indicate one basic time domain unit. FIG. 6 is a diagram of an example of time domain resources configured for a terminal to use in backscatter communication according to an embodiment of this application. In FIG. 6, a case in which M=N=10 and the first bit value is 1 is described. The M resource mapping bits may be 1011011010. Reference may be made to FIG. 6 for a resource of the first time domain resource set 600 that can be used by the terminal device to perform backscatter communication. In FIG. 6, the basic time domain unit 601, the basic time domain unit 603, the basic time domain unit 604, the basic time domain unit 606, the basic time domain unit 607, and the basic time domain unit 609 are time domain resources that can be used by the terminal device to perform backscatter communication.

In a case that M is greater than N, N resource mapping bits in the M resource mapping bits may be in one-to-one association with the N basic time domain units. In other words, each of the N resource mapping bits is respectively associated with one basic time domain unit. M-N resource mapping bits may be used as reserved bits.

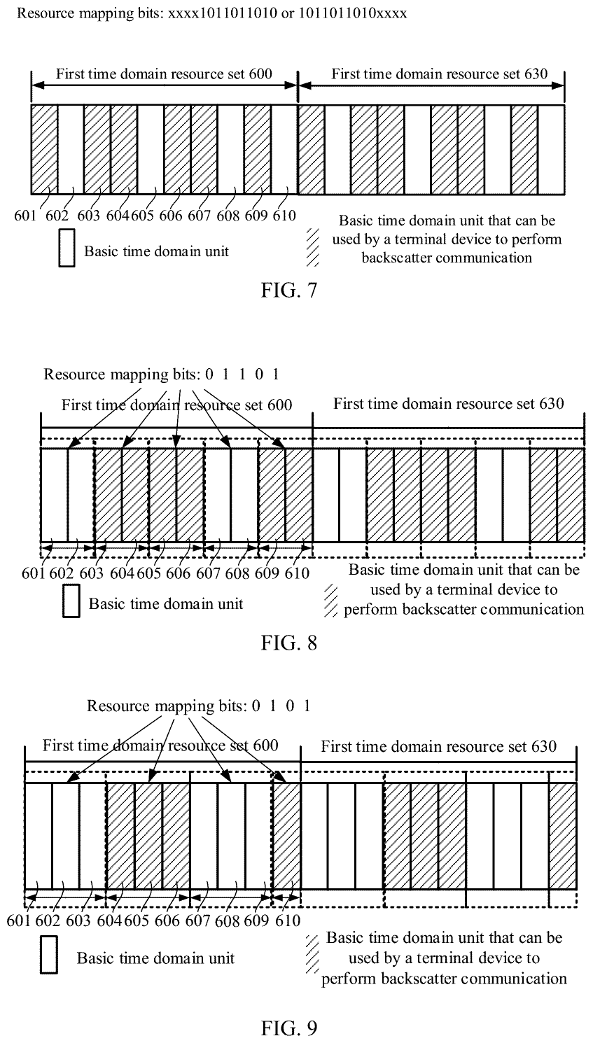

In an implementation, first N consecutive resource mapping bits in the M resource mapping bits may be in one-to-one association with the N basic time domain units. Alternatively, final N consecutive resource mapping bits in the M resource mapping bits may be in one-to-one association with the N basic time domain units. In this case, the M-N consecutive resource mapping bits may be reserved bits. FIG. 7 is a diagram of an example of a first time domain resource set according to an embodiment of this application. In FIG. 7, M=14, N=10, and a first bit value is 1. In M=14 resource mapping bits, first N=10 consecutive resource mapping bits may be associated with N=10 basic time domain units. Alternatively, final N=10 consecutive resource mapping bits may be associated with N=10 basic time domain units. In the M=14 resource mapping bits, four reserved bits may be included, and the four reserved bits may be located at the beginning or end of the M resource mapping bits. For ease of description, the reserved bit is represented by x. The M resource mapping bits may be xxxx1011011010 or 1011011010xxxx. As shown in FIG. 7, a basic time domain unit 601, a basic time domain unit 603, a basic time domain unit 604, a basic time domain unit 606, a basic time domain unit 607, and a basic time domain unit 609 in a first time domain resource set 600 may be time domain resources that can be used by the terminal device to perform backscatter communication.

In a case that M is less than N, a first resource mapping bit may be associated with at least one basic time domain unit. For example, a first resource mapping pattern may include a first resource mapping bit, and the first resource mapping bit may be associated with G or N−(M−1)×G basic time domain units. Herein, G may be configured by a network device, G may be a preset value, or G may be implicitly indicated. For example, G may be obtained through calculation based on M and/or N.

A specific value of G is not limited in this application. For example, G may satisfy G= [N/M] G=N/M, or G=N/M. It may be understood that, if, G= [N/M], N−(M−1)×G may be as small as possible, and M−1 resource mapping bits may be associated with as many basic time domain units as possible. If G=N/MN−(M−1)×G is closer to a value of G, and quantities of units of basic time domain units associated with respective resource mapping bits may be closer to one another. Herein, [ ] represents rounding down, and [ ] represents rounding up. Details are not described below. For example, 3.1 is rounded down to 3, and 3.1 is rounded up to 4.

In an implementation, one bit in the M resource mapping bits may be associated with N−(M−1)×G basic time domain units, and M−1 bits each may be associated with G basic time domain units. For example, the 1^{st} resource mapping bit in the M resource mapping bits may be associated with N−(M−1)×G basic time domain units, and each of the M−1 resource mapping bits may be associated with G basic time domain units. Alternatively, each of M−1 resource mapping bits in the M resource mapping bits may be associated with G basic time domain units in the first time domain resource set, and the final bit is associated with N−(M−1)×G remaining basic time domain units.

It may be understood that, in a case that M<N and M× G=N, N−(M−1)×G and G are equal. In other words, in a case that M<N and M×G=N, M resource mapping bits each may be associated with G basic time domain units. FIG. 8 is a diagram of an example of a first time domain resource set according to an embodiment of this application. In FIG. 8, M=5, N=10, and G=2. Each resource mapping bit may be associated with two basic time domain units. For example, that a value of a resource mapping bit is 1 indicates that an associated basic time domain unit can be used for the terminal to perform backscattering. FIG. 8 may show a case of the first time domain resource set 600 as indicated by a first resource mapping pattern, which is 01101. It can be learned from FIG. 8 that a basic time domain unit 603, a basic time domain unit 604, a basic time domain unit 605, a basic time domain unit 606, a basic time domain unit 609, and a basic time domain unit 610 in the first time domain resource set 600 may be time domain resources that can be used by a terminal device to perform backscatter communication.

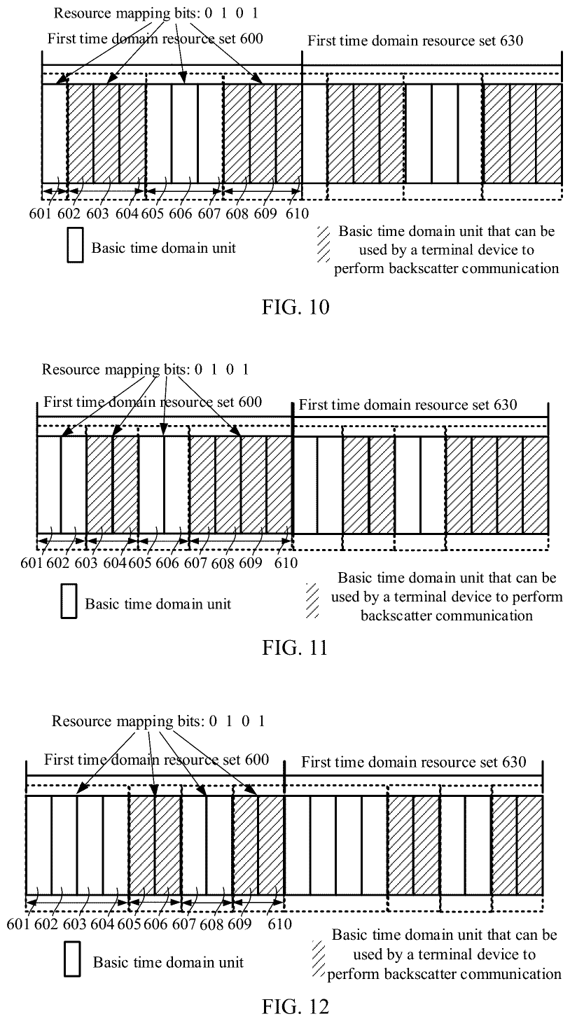

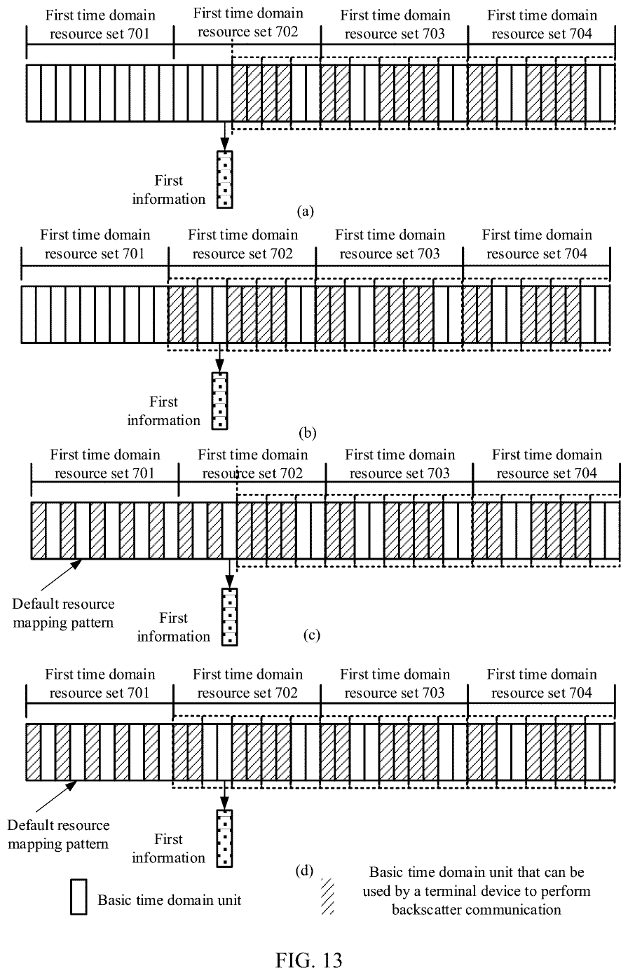

In a case that M<N and M×G≠N, N−(M−1)×G and G are not equal. FIG. 9, FIG. 10, FIG. 11, and FIG. 12 each are a diagram of an example of a first time domain resource set in a case that M<N and M×G≠N according to an embodiment of this application.

In FIG. 9 and FIG. 10, M=4, N=10, and G=┌N/M┌=3. In FIG. 9, first M−1=3 bits each may be associated with G=3 basic time domain units, and a final bit is associated with N−(M−1)×G=1 basic time domain unit. In FIG. 10, the 1^{st} bit is associated with the N−(M−1)×G=1^{st} basic time domain unit, and following M−1=3 bits each are associated with G=3 basic time domain units.

In FIG. 11 and FIG. 12, M=4, N=10, and └G=N/M┘=2. In FIG. 11, first M−1=3 bits each may be associated with G=2 basic time domain units, and a final bit is associated with N−(M−1)×G=4 basic time domain units. In FIG. 12, the 1^{st} bit is associated with N−(M−1)×G=4 basic time domain units, and following M−1=3 bits each are associated with G=2 basic time domain units.

It should be noted that a quantity M of bits of resource mapping bits included in the resource mapping pattern may be a fixed value, or may be not a fixed value. For example, M may be obtained through calculation based on N and/or G.

A value of M is not limited in this application. For example, M may satisfy M=┌N/G└, M=└N/G┘, or M=└N/G┘. Herein, M may have an upper limit value, to avoid an excessively large quantity of bits occupied by the first resource mapping pattern. For example, the upper limit value of M may be represented by Mmax, where Mmax may be an integer greater than 0.

It should be noted that one resource mapping pattern may be used for configuring, by using one first time domain resource set as a granularity, a time domain resource used by a terminal to perform backscatter communication; or may be used for configuring, by using a plurality of first time domain resource sets as a granularity, a time domain resource used by a terminal to perform backscatter communication. In other words, bit mapping can be implemented across first time domain resource sets for one resource mapping pattern. For example, the first time domain resource set includes N basic time units for backscatter communication. The first resource mapping pattern may include M bits for mapping. Herein, M may be twice as large as N. In this case, backscatter resources, which are mapped by the M bits, may span across one or more first time domain resource sets. Alternatively, for the M bits, each bit may be associated with one or more first time domain resource sets. Alternatively, for the M bits, each bit may be associated with G basic units for backscatter communication. In this case, M*G basic units may be associated. These M*G basic units may span across one or more first time domain resource sets.

A manner in which a network device sends first information to a terminal device is not limited in this application.

In an implementation, the first information may be semi-statically configured. For example, the first information may be carried in higher layer signaling dedicated to the terminal. In some embodiments, the first information may be carried in RRC signaling. It may be understood that semi-statical configuration is less sensitive to communication resource overheads than dynamic configuration.

In another implementation, the first information may be configured in a dynamic scheduling manner (that is, configured dynamically). In other words, the time domain resource used for backscatter communication may be dynamically scheduled by the network device by using the first information. For example, the first information may be carried in dynamic control information. The dynamic control information may include first control information that is specifically used for resource control in backscatter communication. Alternatively, the dynamic control information may include control information defined in some communications systems (for example, an NR system). For example, the dynamic control information may be control information transmitted on a channel such as a PDCCH. It may be understood that flexible configuration of the first information may be implemented by configuring the first information in the dynamic scheduling manner.

The following describes configuration of the first information in detail with reference to Embodiment 1 and Embodiment 2. Embodiment 1 is an embodiment in which the first information is semi-statically configured, and Embodiment 2 is an embodiment in which the first information is dynamically configured.

### Embodiment 1

In Embodiment 1, first information may be semi-statically configured by a network device. The first information may be used to indicate a candidate resource mapping pattern. The candidate resource mapping pattern may include one or more resource mapping patterns. The one or more resource mapping patterns may include a first resource mapping pattern.

A terminal may determine, based on the first information, a time domain resource used for backscatter communication from within a target time domain resource set.

A manner of determining the target time domain resource set is not limited in this application.

In an implementation, the target time domain resource set is a first time domain resource set that bears the first information, or the target time domain resource set includes a first time domain resource set that bears the first information and one or more first time domain resource sets that are located after the first time domain resource set that bears the first information.

The first time domain resource set that bears the first information may be a first time domain resource set to which a basic time domain unit in which the terminal receives the first information belongs. In some embodiments, the first time domain resource set that bears the first information may also be referred to as a first time domain resource set in which the terminal receives the first information.

A basic time domain unit in which the terminal receives the first information may be any basic time domain unit in the first time domain resource set. For the first time domain resource set in which the first information is received, the terminal may determine, based on the first information, whether all or some basic time domain units in the first time domain resource set can be used for backscatter communication. For example, for the first time domain resource set in which the first information is received, the terminal may start from the basic time domain unit in which the first information is received or from the y^{th} basic time domain unit after this basic time domain unit, and determine, based on the first information, a resource used for backscatter communication. Herein, y may be an integer greater than 0.

FIG. 13 (a), FIG. 13 (b), FIG. 13 (c), and FIG. 13 (d) each are a diagram of an example of a first time domain resource set according to an embodiment of this application. In FIG. 13 (a), FIG. 13 (b), FIG. 13 (c), or FIG. 13 (d), the first time domain resource set in which the terminal receives the first information is a first time domain resource set 702. Starting from the first time domain resource set 702, the terminal may determine, based on the first information, the time domain resource used for backscatter communication. In FIG. 13 (a) and FIG. 13 (c), starting from a basic time domain unit after the first information is received, the terminal may determine, based on the first information, the time domain resource used for backscatter communication from the first time domain resource set 702. In FIG. 13 (b) and FIG. 13 (d), the terminal may determine, based on the first information, the resource used for backscatter communication from the entire first time domain resource set 702. In FIG. 13 (a) and FIG. 13 (b), before the first information is received, there is no time domain resource that can be used for the terminal to perform backscatter communication. In FIG. 13 (c) and FIG. 13 (d), before receiving the first information, the terminal may determine, based on a default resource mapping pattern, the time domain resource used for backscatter communication.

In an implementation, the target time domain resource set includes one or more first time domain resource sets, the 1^{st} basic time domain unit in the earliest first time domain resource set in the target time domain resource set is a second basic time domain unit, and the second basic time domain unit is used for bearing the first information. In other words, the second basic time domain unit is a basic time domain unit in which the first information is received, and the second basic time domain unit is the 1^{st} basic time domain unit in the first time domain resource set. Starting from the second basic time domain unit, the terminal may determine, based on the first information, the time domain resource used for backscatter communication. It may be understood that in this implementation, the terminal may use the second basic time domain unit as the 1^{st} basic time domain unit in one first time domain unit set, so as to determine a start location of the first time domain resource set.

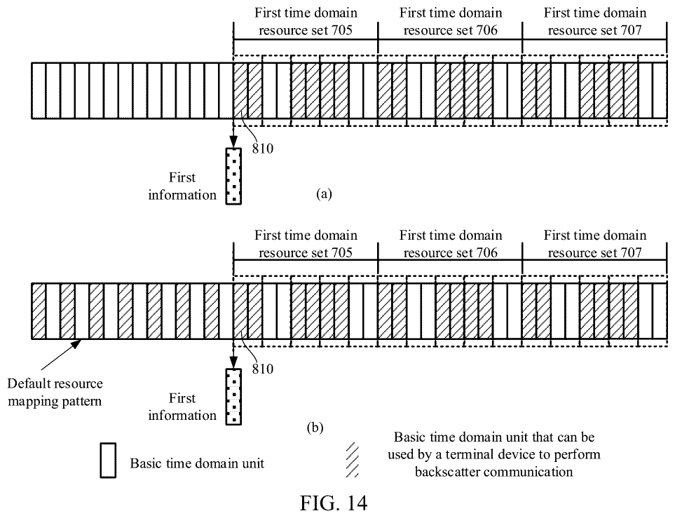

FIG. 14 (a) and FIG. 14 (b) each are a diagram of an example of a first time domain resource set according to an embodiment of this application. In FIG. 14 (a) or FIG. 14 (b), the basic time domain unit in which the first information is received is a second basic time domain unit 810. A first time domain resource set 705 may be determined based on the second time domain unit 810. In other words, the second time domain unit 810 may be the 1^{st} basic time domain unit in the first time domain resource set 705. Starting from the first time domain resource set 705, the terminal may determine, based on the first information, the time domain resource used for backscatter communication. In FIG. 14 (a), before the first information is received, there is no time domain resource that can be used for the terminal to perform backscatter communication. In FIG. 14 (b), before receiving the first information, the terminal may determine, based on a default resource mapping pattern, the time domain resource used for backscatter communication.

In an implementation, the target time domain resource set is the Lth first time domain resource set after a first time domain resource set that bears the first information, or the target time domain resource set includes the Lth first time domain resource set and one or more first time domain resource sets that are located after the Lth first time domain resource set. In other words, starting from the Lth first time domain resource set after the first information is received, the terminal may determine, based on the first information, the time domain resource used for backscatter communication. Herein, L is an integer greater than or equal to 0. Optionally, L may be configured by a network device, or L may be a preset value. For example, L may be configured by using the first information. Alternatively, L may be configured by using other information configured by the network device. It may be understood that, in a case that L=0, the Lth first time domain resource set is a first time domain resource set next to the first time domain resource set in which the first information is received.

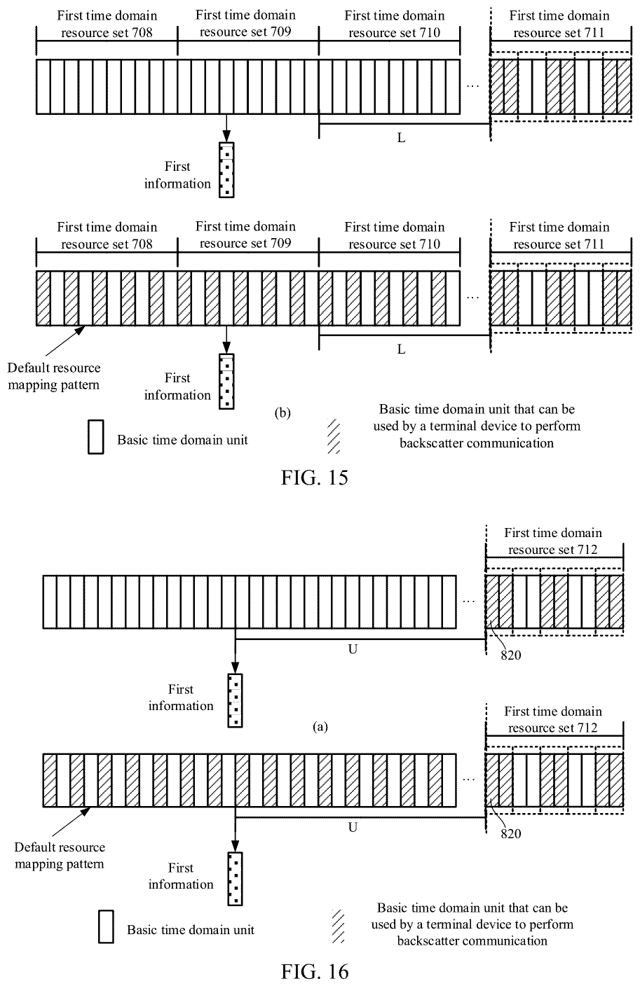

FIG. 15 (a) and FIG. 15 (b) each are a diagram of an example of a first time domain resource set according to an embodiment of this application. In FIG. 15 (a) or FIG. 15 (b), the first time domain resource set in which the terminal receives the first information is a first time domain resource set 709. The Lth first time domain resource set after the first time domain resource set 709 is a first time domain resource set 711. Starting from the first time domain resource set 711, the terminal may determine, based on the first information, the time domain resource used for backscatter communication. In FIG. 15 (a), before the first time domain resource set 711, there is no time domain resource that can be used for the terminal to perform backscatter communication. In FIG. 15 (b), before the first time domain resource set 711, the terminal may determine, based on a default resource mapping pattern, the time domain resource used for backscatter communication.

In an implementation, the target time domain resource set includes one or more first time domain resource sets, the 1^{st} basic time domain unit in the earliest first time domain resource set in the target time domain resource set is a third basic time domain unit, and the third basic time domain unit is the U^{th} basic time domain unit after a second basic time domain unit that bears the first information. In other words, starting from the third basic time domain unit, the terminal may determine, based on the first information, the time domain resource used for backscatter communication. The third basic time domain unit is the U^{th} basic time domain unit after the first information is received, and the third basic time domain unit is the 1^{st} basic time domain unit in the first time domain resource set. Herein, U is an integer greater than or equal to 0. Optionally, U may be configured by the network device, or U may be a preset value. For example, U may be configured by using the first information. Alternatively, U may be configured by using other information configured by the network device. It may be understood that, in a case that U=0, the U^{th} basic time domain unit is a basic time domain unit next to the basic time domain unit in which the first information is received.

FIG. 16 (a) and FIG. 16 (b) each are a diagram of an example of a first time domain resource set according to an embodiment of this application. In FIG. 16 (a) or FIG. 16 (b), the U^{th} basic time domain unit after the first information is received is a third basic time domain unit 820. The third time domain unit 820 may be the 1^{st} basic time domain resource in a first time domain resource set 712. Starting from the first time domain resource set 712, the terminal may determine, based on the first information, the time domain resource used for backscatter communication. In FIG. 16 (a), before the first time domain resource set 712, there is no time domain resource that can be used for the terminal to perform backscatter communication. In FIG. 16 (b), before the first time domain resource set 712, the terminal may determine, based on a default resource mapping pattern, the time domain resource used for backscatter communication.

In some implementations, the method shown in FIG. 5 may further include step S520. Step S520: The network device sends second information to the terminal.

The second information may be used to indicate the target time domain resource set. The terminal may determine, based on the first information, the time domain resource used for backscatter communication from the target time domain resource set. It may be understood that the second information may be used to indicate an effective time of the first information. Before receiving the second information, the terminal may determine, according to a preset rule (for example, based on a default pattern), the time domain resource used for backscatter communication. Alternatively, before the terminal receives the second information, there is no time domain resource in time domain resources that can be used by the terminal to perform backscattering. After receiving the second information, starting from an effective time indicated with the second information, the terminal may determine, based on the first information, the time domain resource used for backscatter communication. The second information may be, for example, dynamically configured.

In some embodiments, the target time domain resource set is a first time domain resource set that bears the second information; or the target time domain resource set includes a first time domain resource set that bears the second information and one or more first time domain resource sets that are located after the first time domain resource set that bears the first information. In other words, starting from the first time domain resource set in which the second information is received, the terminal may determine, based on the first information, the time domain resource used for backscatter communication.

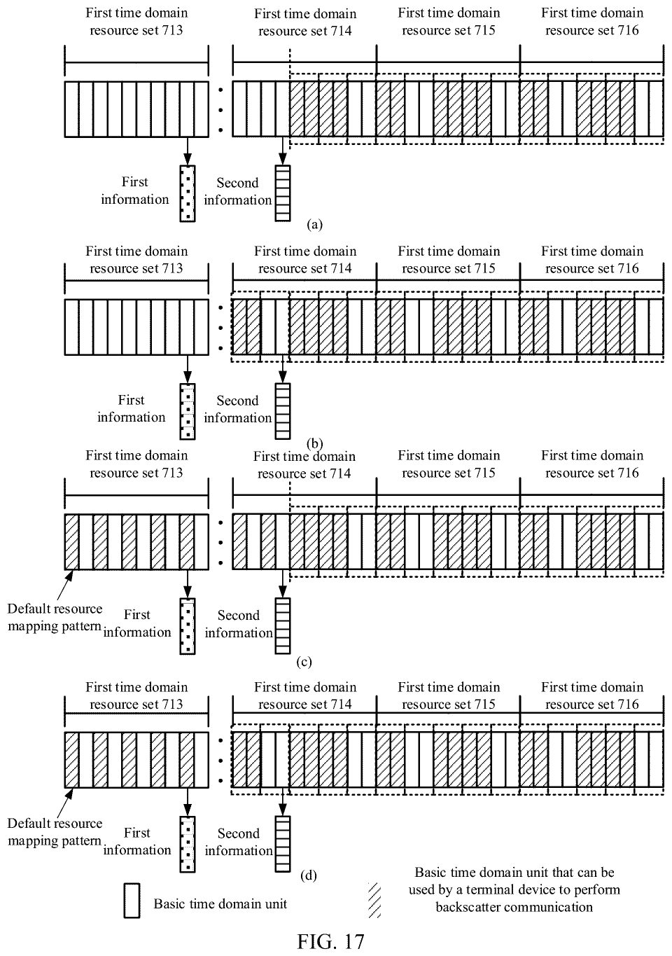

FIG. 17 (a), FIG. 17 (b), FIG. 17 (c), and FIG. 17 (d) each are a diagram of an example of a first time domain resource set according to an embodiment of this application. In FIG. 17 (a), FIG. 17 (b), FIG. 17 (c), or FIG. 17 (d), the terminal receives the first information in a first time domain resource set 713, and receives the second information in a first time domain resource set 714. Between the first time domain resource set 713 and the first time domain resource set 714, the terminal may not determine, based on the first information, the time domain resource used for backscatter communication. Starting from the first time domain resource set 714, the terminal may determine, based on the first information, the time domain resource used for backscatter communication. In FIG. 17 (a) and FIG. 17 (c), starting from a basic time domain unit after the second information is received, the terminal may determine, based on the first information, the time domain resource used for backscatter communication from within the first time domain resource set 714. In FIG. 17 (b) and FIG. 17 (d), the terminal may determine, based on the first information, the resource used for backscatter communication from within the entire first time domain resource set 714. In FIG. 17 (a) and FIG. 17 (b), before the second information is received, there is no time domain resource that can be used for the terminal to perform backscatter communication. In FIG. 17 (c) and FIG. 17 (d), before receiving the second information, the terminal may determine, based on a default resource mapping pattern, the time domain resource used for backscatter communication.

In some other embodiments, the target time domain resource set includes one or more first time domain resource sets, the 1^{st} basic time domain unit in the earliest first time domain resource set in the target time domain resource set is a fourth basic time domain unit, and the fourth basic time domain unit is used for bearing the second information. In other words, starting from the fourth basic time domain unit, the terminal may determine, based on the first information, the time domain resource used for backscatter communication. The fourth basic time domain unit is a basic time domain unit in which the second information is received, and the fourth basic time domain unit is the 1^{st} basic time domain unit in the first time domain resource set. It may be understood that in this implementation, the terminal may use the fourth basic time domain unit as the 1^{st} basic time domain unit in one first time domain unit set, so as to determine a start location of the first time domain resource set.

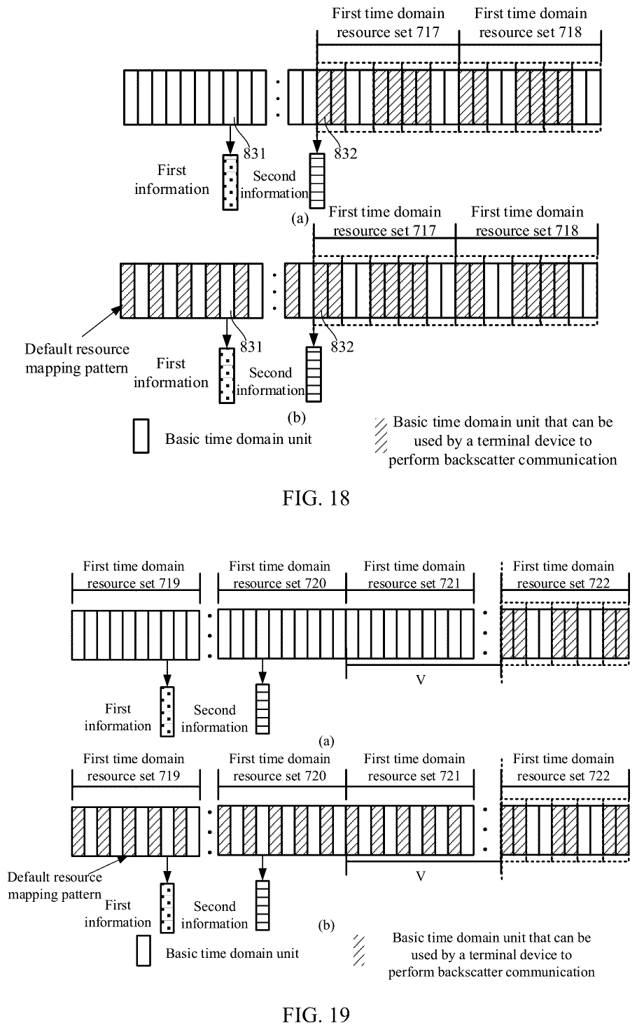

FIG. 18 (a) and FIG. 18 (b) each are a diagram of an example of a first time domain resource set according to an embodiment of this application. In FIG. 18 (a) or FIG. 18 (b), the terminal receives the first information in a basic time domain unit 831. After receiving the first information, the terminal device may not immediately determine, based on the first information, the time domain resource used for backscatter communication. A basic time domain unit in which the second information is received is a fourth basic time domain unit 832. The fourth basic time domain unit 832 may be the 1^{st} basic time domain unit in a first time domain resource set 717. Starting from the first time domain resource set 717, the terminal may determine, based on the first information, the time domain resource used for backscatter communication. In FIG. 18 (a), before the second information is received, there is no time domain resource that can be used for the terminal to perform backscatter communication. In FIG. 18 (b), before receiving the second information, the terminal may determine, based on a default resource mapping pattern, the time domain resource used for backscatter communication.

In some implementations, the target time domain resource set is the V^{th} first time domain resource set after a first time domain resource set that bears the second information, or the target time domain resource set includes the V^{th} first time domain resource set and one or more first time domain resource sets that are located after the V^{th} first time domain resource set. In other words, starting from the V^{th} first time domain resource set after the second information is received, the terminal may determine, based on the first information, the time domain resource used for backscatter communication. Herein, V may be an integer greater than or equal to 0. Optionally, V may be configured by the network device, or V may be a preset value. For example, V may be configured by using the first information or the second information. Alternatively, V may be configured by using other information configured by the network device. It may be understood that, in a case that V=0, the V^{th} first time domain resource set is a first time domain resource set next to the first time domain resource set in which the second information is received.

FIG. 19 (a) and FIG. 19 (b) each are a diagram of an example of a first time domain resource set according to an embodiment of this application. In FIG. 19 (a) or FIG. 19 (b), the terminal receives the first information in a first time domain resource set 719, and receives the second information in a first time domain resource set 720. Between the first time domain resource set 719 and the first time domain resource set 720, the terminal may not determine, based on the first information, the time domain resource used for backscatter communication. Starting from the V^{th} first time domain resource set 722 after the first time domain resource set 720, the terminal may determine, based on the first information, the time domain resource used for backscatter communication. In FIG. 19 (a), before the first time domain resource set 722, there is no time domain resource that can be used for the terminal to perform backscatter communication. In FIG. 19 (b), before the first time domain resource set 722, the terminal may determine, based on a default resource mapping pattern, the time domain resource used for backscatter communication.

In some implementations, the target time domain resource set includes one or more first time domain resource sets, the 1^{st} basic time domain unit in the earliest first time domain resource set in the target time domain resource set is a fifth basic time domain unit, and the fifth basic time domain unit is the p^{th} basic time domain unit after a fourth basic time domain unit that bears the second information. In other words, starting from the fifth basic time domain unit, the terminal may determine, based on the first information, the time domain resource used for backscatter communication. The fifth basic time domain unit is the p^{th} basic time domain unit after the second information is received, and the fifth basic time domain unit is the 1^{st} basic time domain unit in the first time domain resource set, where P is an integer greater than or equal to 0. It may be understood that in this implementation, the terminal may use the fifth basic time domain unit as the 1^{st} basic time domain unit in one first time domain unit set, so as to determine a start location of the first time domain resource set.

Optionally, P may be configured by the network device, or P may be a preset value. For example, P may be configured by using the first information or the second information. Alternatively, P may be configured by using other information configured by the network device. In a case that P=0, the P^{th} basic time domain unit may be a first basic time domain unit next to the basic time domain unit in which the second information is received.

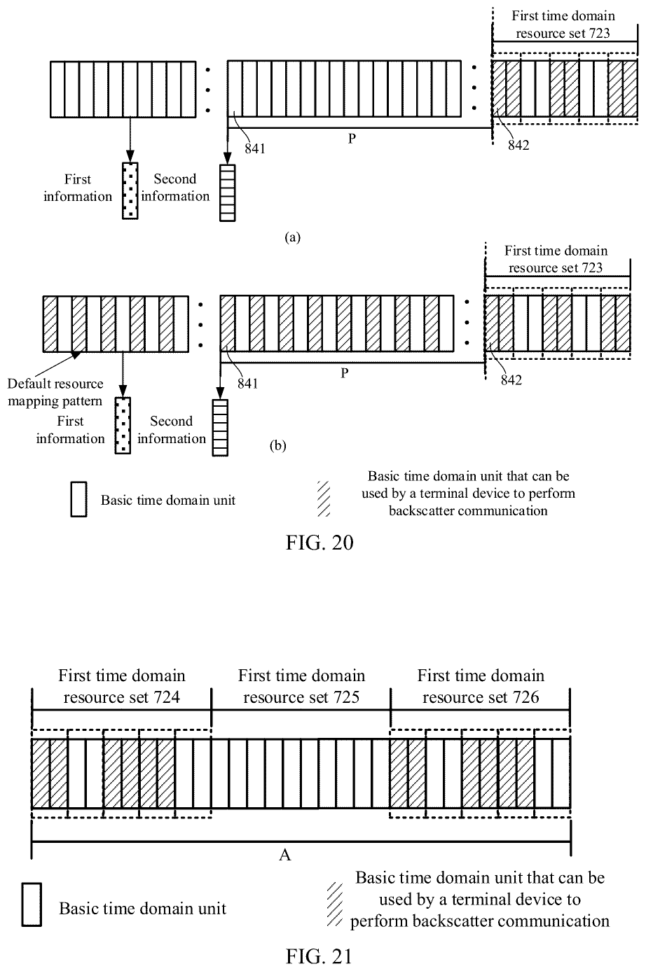

FIG. 20 (a) and FIG. 20 (b) each are a diagram of an example of a first time domain resource set according to an embodiment of this application. In FIG. 20 (a) or FIG. 20 (b), after receiving the first information, the terminal may not immediately determine, based on the first information, the time domain resource used for backscatter communication. The basic time domain unit in which the second information is received is a basic time domain unit 841. A fifth basic time domain unit 842 may be the p^{th} basic time domain unit after the basic time domain unit 841. The terminal may use the basic time domain unit 842 as the 1^{st} basic time domain unit in a first time domain resource set 723. Starting from the fifth basic time domain unit 842, the terminal may determine, based on the first information, the time domain resource used for backscatter communication. In FIG. 20 (a), before the fifth basic time domain unit 842, there is no time domain resource that can be used for the terminal to perform backscatter communication. In FIG. 20 (b), before the fifth basic time domain unit 842, the terminal may determine, based on a default resource mapping pattern, the time domain resource used for backscatter communication.

It should be noted that, in some embodiments, the first time domain resource set in which the first information is received may also be referred to as a current first time domain resource set. The basic time domain unit in which the first information is received may also be referred to as a current basic time domain unit.

The terminal may determine, based on the first information, the resource used for backscatter communication from one or more consecutive first time domain resource sets. Alternatively, the terminal may determine, based on the first information, the resource used for backscatter communication from one or more inconsecutive first time domain resource sets.

A first time domain resource set associated with one or more resource mapping patterns indicated by the first information may be indicated by using a first rule. In other words, the first rule may include a feature of the first time domain resource set to which the one or more resource mapping patterns are applied. For example, according to the first rule, the terminal may determine the feature of the first time domain resource set to which the one or more resource mapping patterns are applied, and determine one or more first time domain resource sets to which the one or more resource mapping patterns are applied. Then, based on the one or more resource mapping patterns, the terminal may determine the time domain resource used for backscatter communication from within the one or more first time domain resource sets. The plurality of first time domain resource sets to which the one or more resource mapping patterns are applied may be consecutive or inconsecutive.

In an implementation, the terminal may determine, based on one or more resource mapping patterns indicated by the first information, the time domain resource used for backscatter communication for a first time domain resource set that meets the first rule. A first time domain resource set that does not meet the first rule may not include the time domain resource that can be used for the terminal to perform backscatter communication. For example, the terminal may determine, based on a default resource mapping pattern, the time domain resource used for backscatter communication for the first time domain resource set that does not meet the first rule. Alternatively, the terminal may not determine the time domain resource used for backscatter communication for the first time domain resource set that does not meet the first rule.

For ease of understanding, the following describes the first rule by way of example. The feature, included in the first rule, of the first time domain resource set to which the one or more resource mapping patterns are applied may be: In every A first time domain resource sets, the a^{th} first time domain resource set may be a first time domain resource set on which the one or more resource mapping patterns indicated by the first information take effect. The following uses FIG. 21 as an example for description. In FIG. 21, A=3, and a=1 or 3. In every A=3 first time domain resource sets, the 1^{st} first time domain resource set (for example, a first time domain resource set 724) and the 3^{rd} first time domain resource set (for example, a first time domain resource set 726) are first time domain resource sets on which the one or more resource mapping patterns indicated by the first information take effect. A first time domain resource set 725 may use a default resource mapping pattern, or a first time domain resource set 725 does not include the resource used by the terminal to perform backscatter communication.

As described above, a semi-statically configured candidate resource mapping pattern may include one or more resource mapping patterns. In a case that the candidate resource mapping pattern includes a plurality of resource mapping patterns, a quantity of basic time domain units, which are associated with one resource mapping bit in a resource mapping pattern, in a first time domain resource set may be the same as or different from a quantity of basic time domain units, which are associated with one resource mapping bit in another resource mapping pattern, in the first time domain resource set. For example, the plurality of resource mapping patterns include a first resource mapping pattern and a second resource mapping pattern, the first resource mapping pattern includes a first resource mapping bit, the second resource mapping pattern includes a second resource mapping bit, a quantity of units of basic time domain units associated with the first resource mapping bit is a first quantity, a quantity of units of basic time domain units associated with the second resource mapping bit is a second quantity, and the first quantity and the second quantity are not equal.

In addition, in a case that the candidate resource mapping pattern includes a plurality of resource mapping patterns, quantities of bits of resource mapping bits included in different resource mapping patterns may be the same or different. For example, the plurality of resource mapping patterns include a second resource mapping pattern, a quantity of bits of resource mapping bits in the first resource mapping pattern is a first quantity of bits, a quantity of bits of resource mapping bits in the second resource mapping pattern is a second quantity of bits, and the first quantity of bits and the second quantity of bits are not equal.

It may be understood that in a case that the candidate resource mapping pattern includes a plurality of resource mapping patterns, the following cases may exist: The first quantity and the second quantity are equal, and the first quantity of bits and the second quantity of bits are not equal; the first quantity and the second quantity are equal, and the first quantity of bits and the second quantity of bits are not equal; the first quantity and the second quantity are not equal, and the first quantity of bits and the second quantity of bits are equal; and the first quantity and the second quantity are not equal, and the first quantity of bits and the second quantity of bits are equal.

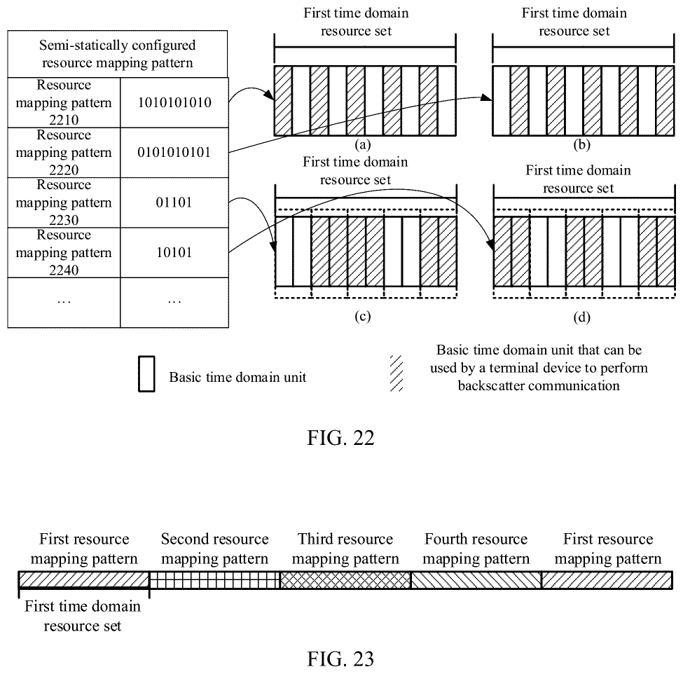

FIG. 22 is a diagram of an example of a plurality of resource mapping patterns being indicated with first information. The plurality of resource mapping patterns may include a resource mapping pattern 2210, a resource mapping pattern 2220, a resource mapping pattern 2230, and a resource mapping pattern 2240. Each resource mapping bit in the resource mapping pattern 2220 may be associated with one basic time domain unit. The resource mapping pattern 2210 includes 10 resource mapping bits: 1010101010. FIG. 22 (a) shows a status of a resource, in a first time domain resource set indicated by the resource mapping pattern 2210, that can be used by the terminal to perform backscattering. Each resource mapping bit in the resource mapping pattern 2220 may be associated with one basic time domain unit. The resource mapping pattern 2220 includes 10 resource mapping bits: 0101010101. FIG. 22 (b) shows a status of a resource, in a first time domain resource set indicated by the resource mapping pattern 2220, that can be used by the terminal to perform backscattering. Each resource mapping bit in the resource mapping pattern 2230 may be associated with two basic time domain units. The resource mapping pattern 2230 includes five resource mapping bits: 01101. FIG. 22 (c) shows a status of a resource, in a first time domain resource set indicated by the resource mapping pattern 2230, that can be used by the terminal to perform backscattering. Each resource mapping bit in the resource mapping pattern 2240 may be associated with two basic time domain units. The resource mapping pattern 2240 includes five resource mapping bits: 10101. FIG. 22 (d) shows a status of a resource, in a first time domain resource set indicated by the resource mapping pattern 2240, that can be used by the terminal to perform backscattering.

It may be understood that, in a case that the candidate resource mapping pattern includes one resource mapping pattern (that is, the first resource mapping pattern), the terminal may determine, based on the first resource mapping pattern, the time domain resource used for backscatter communication. In a case that the candidate resource mapping pattern includes a plurality of resource mapping patterns, the terminal may determine, based on one resource mapping pattern (that is, the first resource mapping pattern) of the plurality of resource mapping patterns, the time domain resource used for backscatter communication. The first resource mapping pattern may be, for example, the 1^{st} resource mapping pattern or the final mapping pattern in the plurality of resource mapping patterns.

In a case that the candidate resource mapping pattern includes a plurality of resource mapping patterns, the terminal may determine, based on at least two periodic resource mapping patterns of the plurality of resource mapping patterns, the time domain resource used for backscatter communication. The at least two periodic resource mapping patterns are used for alternately configuring, in one period for the terminal, the time domain resource used for backscatter communication. The at least two periodic resource mapping patterns may also be used for alternately configuring, in one period for the terminal, the time domain resource used for backscatter communication. For example, the terminal may dynamically switch different resource mapping patterns to determine the time domain resource used for backscatter communication. In an implementation, the terminal may periodically switch at least two resource mapping patterns. For example, the first information may indicate Nx resource mapping patterns, and Mx resource mapping patterns of the Nx resource mapping patterns may be used as periodic resource mapping patterns. The terminal may use a corresponding periodic resource mapping pattern based on an index i of a first time domain resource set. To be specific, the (((i+k) mod Mx)+m)^{th} periodic resource mapping pattern may be used for the i^{th} first time domain resource set. Herein, Mx is an integer greater than 1, Nx is an integer greater than Mx, i is an integer greater than or equal to 0, m is an integer greater than or equal to 0, and k is an integer greater than or equal to 0. For example, the (i mod Mx) th or the ((i mod Mx)+1) th periodic resource mapping pattern may be used for the i^{th} first time domain resource set.

FIG. 23 is a diagram of an example of periodically switching between resource mapping patterns according to an embodiment of this application. The first information may indicate at least four periodic resource mapping patterns (that is, Nx≥4). The at least four periodic resource mapping patterns may include a first resource mapping pattern, a second resource mapping pattern, a third resource mapping pattern, and a fourth resource mapping pattern (that is, Mx=4). The terminal may periodically use a respective resource mapping pattern in an order of the first resource mapping pattern, the second resource mapping pattern, the third resource mapping pattern, and the fourth resource mapping pattern, to indicate a resource of a time domain resource for backscatter communication, which is determined by the terminal, in the first time domain resource set.

Optionally, the method shown in FIG. 5 may further include step S530. Step S530: The network device sends third information to the terminal.

The third information may be used for instructing the terminal to determine, based on the first resource mapping pattern in the plurality of resource mapping patterns, the time domain resource used for backscatter communication. The third information may be configured in a dynamic scheduling manner. In other words, the terminal may determine, based on the third information from the plurality of resource mapping patterns indicated by the first information, an resource mapping pattern that is to be applied.

It may be understood that, in a case that the candidate resource mapping pattern that is semi-statically configured by the network device by using the first information includes a plurality of resource mapping patterns, one resource mapping pattern (that is, the first resource mapping pattern) is indicated based on the third information, and the terminal may determine, based on this resource mapping pattern, the time domain resource used for backscatter communication.

Optionally, the third information may include identification information of the first resource mapping pattern. For example, the identification information may include an index of the resource mapping pattern. The identification information may be alternatively represented by a codepoint (codepoint). In other words, different codepoints may be associated with different resource mapping patterns. For example, “00” may represent the first resource mapping pattern, “01” may represent the second resource mapping pattern, “11” may represent the third resource mapping pattern, and “10” may represent the fourth resource mapping pattern. The terminal device may determine the first resource mapping pattern based on the identification information, so as to further determine the time domain resource used for backscatter communication.

It should be noted that the condition of resources as used by the terminal for backscatter communication when the terminal does not receive the third information is not limited in the application. For example, the terminal may determine, based on a default resource mapping pattern (which may be dedicatedly configured or determined from a plurality of configured resource mapping patterns according to a preset rule), the time domain resource used for backscatter communication. Alternatively, the terminal may use a certain resource mapping pattern (for example, the 1^{st} or the final resource mapping pattern, or a resource mapping pattern determined according to a preset rule) in the plurality of resource mapping patterns configured by using the first information. In particular, the certain resource mapping pattern in the plurality of resource mapping patterns may be referred to as a default pattern determined according to a preset rule.

Optionally, when the terminal receives the third information, the terminal may determine, based on the third information, the first resource mapping pattern in the plurality of resource mapping patterns configured by using the first information, and determine, based on the first resource mapping pattern, the time domain resource used for backscatter communication within a target time domain resource set.

A method for determining a target time domain resource is not limited in this application.

In some implementations, the target time domain resource set may be a first time domain resource set that bears the third information, or the target time domain resource set includes a first time domain resource set that bears the third information and one or more first time domain resource sets that are located after the first time domain resource set that bears the third information. In other words, starting from the first time domain resource set in which the third information is received, the terminal may determine, based on the third information, the time domain resource used for backscatter communication.

The first time domain resource set in which the third information is received may be a first time domain resource set to which a basic time domain unit in which the terminal receives the third information belongs. The basic time domain unit in which the terminal receives the third information may be any basic time domain unit in the first time domain resource set. For the first time domain resource set in which the third information is received, the terminal may determine, based on the third information, whether all or some basic time domain units in this first time domain resource set can be used for backscatter communication.

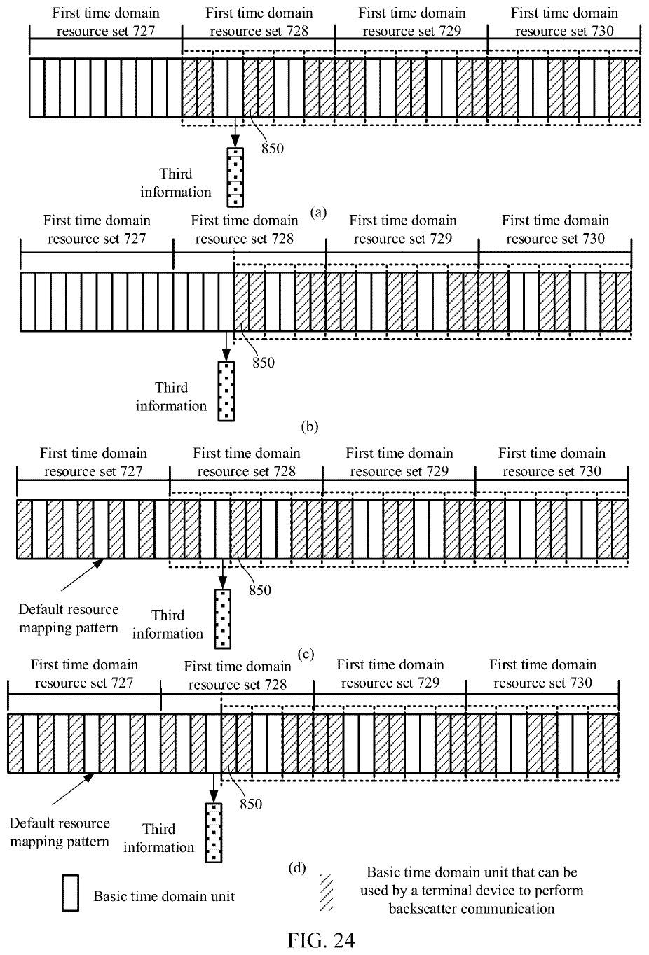

FIG. 24 (a), FIG. 24 (b), FIG. 24 (c), and FIG. 24 (d) each are a diagram of an example of a first time domain resource set according to an embodiment of this application. In FIG. 24 (a), FIG. 24 (b), FIG. 24 (c), or FIG. 24 (d), the terminal receives the third information in a first time domain resource set 728. For example, the first information includes the plurality of resource mapping patterns shown in FIG. 22. In this case, the third information may be used for instructing the terminal to use the resource mapping pattern 2240. Starting from a basic time domain unit 850 in the first time domain resource set 728, the terminal may determine, based on a new resource mapping pattern (that is, the resource mapping pattern 2240), the time domain resource used for backscatter communication. Before the basic time domain unit 850, the terminal device may determine, based on an old pattern (for example, a default resource mapping pattern), the time domain resource used for backscatter communication. In FIG. 24 (a) and FIG. 24 (c), the terminal may determine, based on the third information, the resource used for backscatter communication from within the entire first time domain resource set 728. In FIG. 24 (b) and FIG. 24 (d), starting from a basic time domain unit after the third information is received, the terminal may determine, based on the third information, the time domain resource used for backscatter communication from within the first time domain resource set 728. In FIG. 24 (a) and FIG. 24 (b), before the third information is received, there is no time domain resource that can be used for the terminal to perform backscatter communication. In FIG. 24 (c) and FIG. 24 (d), before receiving the third information, the terminal may determine, based on a default resource mapping pattern, the time domain resource used for backscatter communication.

In some implementations, the target time domain resource set includes one or more first time domain resource sets, the 1^{st} basic time domain unit in the earliest first time domain resource set in the target time domain resource set is a sixth basic time domain unit, and the sixth basic time domain unit is used for bearing the third information. In other words, starting from the sixth basic time domain unit, the terminal may determine, based on the third information, the time domain resource used for backscatter communication. The sixth basic time domain unit is a basic time domain unit in which the third information is received, and the sixth basic time domain unit is the 1^{st} basic time domain unit in the first time domain resource set. It may be understood that in this implementation, the terminal may use the sixth basic time domain unit as the 1^{st} basic time domain unit in one first time domain unit set, so as to determine a start location of the first time domain resource set.

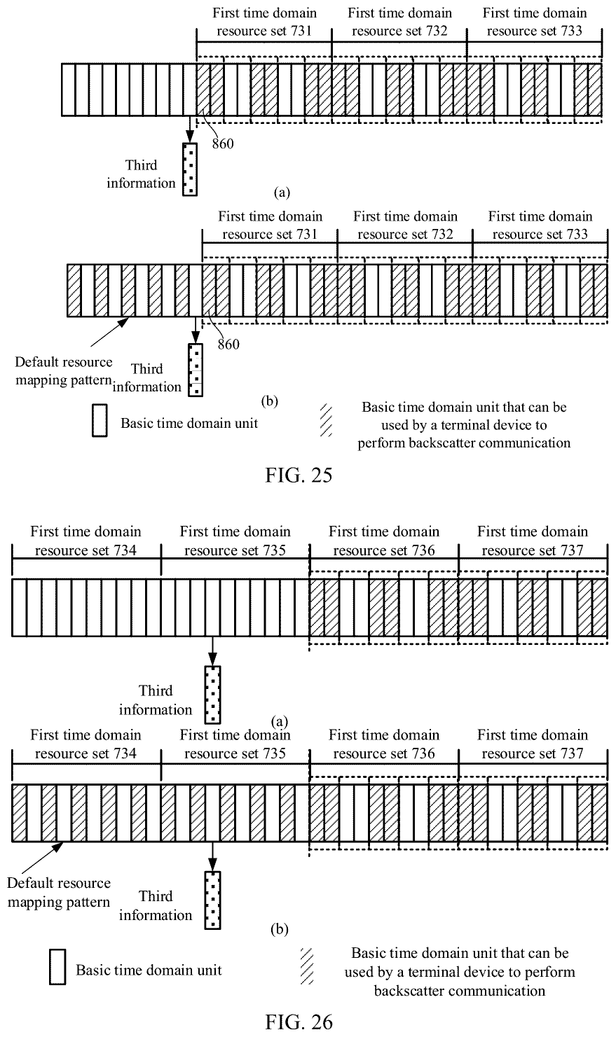

FIG. 25 (a) and FIG. 25 (b) each are a diagram of an example of a first time domain resource set according to an embodiment of this application. In FIG. 25 (a) or FIG. 25 (b), the basic time domain unit in which the terminal receives the third information is a sixth basic time domain unit 860. For example, the first information includes the plurality of resource mapping patterns shown in FIG. 22. In this case, the third information may be used for instructing the terminal to use the resource mapping pattern 2240. The sixth basic time domain unit may be the 1^{st} basic time domain unit in a first time domain resource set 731. Starting from the first time domain resource set 731, the terminal may determine, based on a new resource mapping pattern (that is, the resource mapping pattern 2240), the time domain resource used for backscatter communication. Before the basic time domain unit 860, the terminal device may determine, based on an old pattern (for example, a default resource mapping pattern), the time domain resource used for backscatter communication. In FIG. 25 (a), before the third information is received, there is no time domain resource that can be used for the terminal to perform backscatter communication. In FIG. 25 (b), before receiving the third information, the terminal may determine, based on a default resource mapping pattern, the time domain resource used for backscatter communication.

In some implementations, starting from the next first time domain resource set after the third information is received, the terminal may determine, based on the third information, the time domain resource used for backscatter communication.

In some implementations, starting from the Q^{th} first time domain resource set after the third information is received, the terminal determines, based on the third information, the time domain resource used for backscatter communication. Herein, Q is an integer greater than or equal to 0. Optionally, Q may be configured by the network device, or Q may be a preset value. For example, Q may be configured by using the third information. Alternatively, Q may be configured by using other information configured by the network device. It may be understood that, in a case that Q=0, the Q^{th} first time domain resource set may be a first time domain resource set next to the first time domain resource set in which the third information is received.

FIG. 26 (a) and FIG. 26 (b) each are a diagram of an example of a first time domain resource set according to an embodiment of this application. In FIG. 26 (a) or FIG. 26 (b), the terminal receives the third information in a first time domain resource set 735. For example, the first information includes the plurality of resource mapping patterns shown in FIG. 22. In this case, the third information may be used for instructing the terminal to use the resource mapping pattern 2240. Starting from the 1^{st} basic time domain unit in a first time domain resource set 736 next to the first time domain resource set 735, the terminal may determine, based on a new resource mapping pattern (that is, the resource mapping pattern 2240), the time domain resource used for backscatter communication. Before the first time domain resource set 736, the terminal device may determine, based on an old pattern (for example, a default resource mapping pattern), the time domain resource used for backscatter communication. In FIG. 26 (a), before the first time domain resource set 736, there is no time domain resource that can be used for the terminal to perform backscatter communication. In FIG. 26 (b), before the first time domain resource set 736, the terminal may determine, based on a default resource mapping pattern, the time domain resource used for backscatter communication.

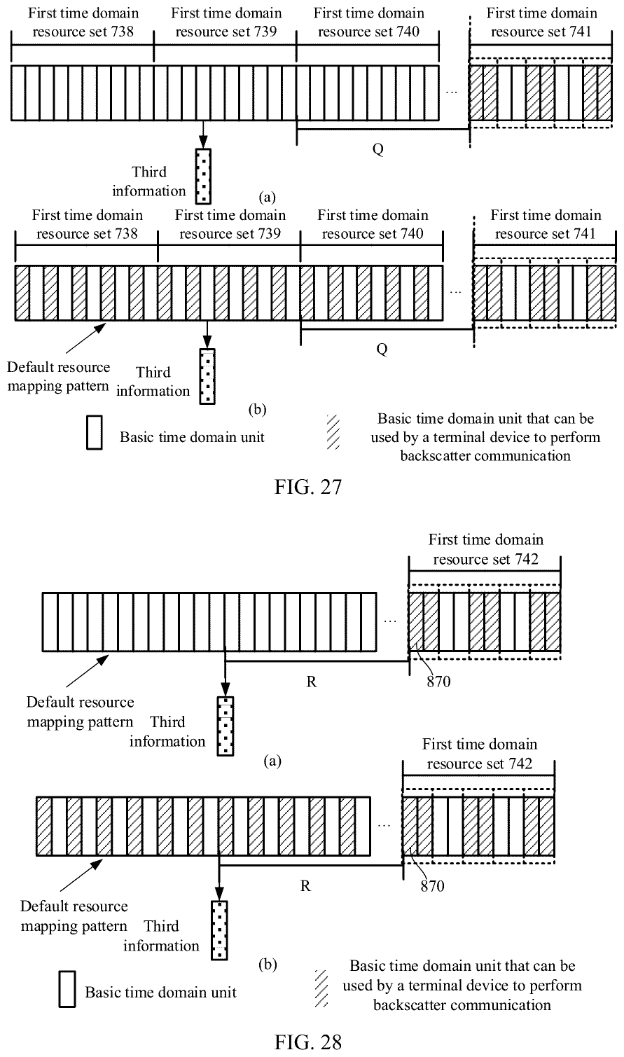

FIG. 27 (a) and FIG. 27 (b) each are a diagram of an example of a first time domain resource set according to an embodiment of this application. In FIG. 27 (a) or FIG. 27 (b), the terminal receives the third information in a first time domain resource set 739. For example, the first information includes the plurality of resource mapping patterns shown in FIG. 22. In this case, the third information may be used for instructing the terminal to use the resource mapping pattern 2240. Starting from the 1^{st} basic time domain unit in the Q^{th} first time domain resource set 741 after the first time domain resource set 739, the terminal may determine, based on a new resource mapping pattern (that is, the resource mapping pattern 2240), the time domain resource used for backscatter communication. Before the first time domain resource set 741, the terminal may determine, based on an old pattern (for example, a default resource mapping pattern), the time domain resource used for backscatter communication. In FIG. 27 (a), before the first time domain resource set 741, there is no time domain resource that can be used for the terminal to perform backscatter communication. In FIG. 27 (b), before the first time domain resource set 741, the terminal may determine, based on a default resource mapping pattern, the time domain resource used for backscatter communication.

Alternatively, the target time domain resource set includes one or more first time domain resource sets, the 1^{st} basic time domain unit in the earliest first time domain resource set in the target time domain resource set is a seventh basic time domain unit, and the seventh basic time domain unit is the R^{th} basic time domain unit after a sixth basic time domain unit that bears the third information. In other words, starting from the seventh basic time domain unit, the terminal may determine, based on the third information, the time domain resource used for backscatter communication. The seventh basic time domain unit is the R^{th} basic time domain unit after the third information is received, and the seventh basic time domain unit is the 1^{st} basic time domain unit in the first time domain resource set, where R is an integer greater than or equal to 0. Herein, R may be configured by the network device, or R is a preset value. For example, R may be configured by using the third information. Alternatively, R may be configured by using other information configured by the network device. In a case that R=0, the R^{th} basic time domain unit is a basic time domain unit next to the basic time domain unit in which the third information is received.

FIG. 28 (a) or FIG. 28 (b) is a diagram of an example of a first time domain resource set according to an embodiment of this application. In FIG. 28 (a) or FIG. 28 (b), the R^{th} basic time domain unit after the terminal receives the third information is a seventh basic time domain unit 870. The seventh basic time domain unit 870 may be the 1^{st} basic time domain unit in a first time domain resource set 742. For example, the first information includes the plurality of resource mapping patterns shown in FIG. 22. In this case, the third information may be used for instructing the terminal to use the resource mapping pattern 2240. Starting from the seventh basic time domain unit 870, the terminal may determine, based on a new resource mapping pattern (that is, the resource mapping pattern 2240), the time domain resource used for backscatter communication. Before the first time domain resource set 742, the terminal may determine, based on an old pattern (for example, a default resource mapping pattern), the time domain resource used for backscatter communication. In FIG. 28 (a), before the first time domain resource set 742, there is no time domain resource that can be used for the terminal to perform backscatter communication. In FIG. 28 (b), before the first time domain resource set 742, the terminal may determine, based on a default resource mapping pattern, the time domain resource used for backscatter communication.

In an implementation, when the terminal determines, based on the third information, the time domain resource used for backscatter communication, for a first time domain resource set that meets a second rule, the terminal may determine, based on a resource mapping pattern identifier indicated by the third information, the time domain resource used for backscatter communication. The second rule may include a feature of the first time domain resource set to which the first resource mapping pattern is applied. In other words, the second rule may be used to indicate one or more first time domain resource sets associated with the first resource mapping pattern. The terminal may not determine, based on the third information, the time domain resource used for backscatter communication for a first time domain resource set that does not meet the second rule. For example, the terminal may determine, based on a default resource mapping pattern, the time domain resource used for backscatter communication for the first time domain resource set that does not meet the second rule. Alternatively, the terminal may not determine, based on the third information, the time domain resource used for backscatter communication for a first time domain resource set that does not meet the second rule. For example, the feature, included in the second rule, of the first time domain resource set to which the first resource mapping pattern is applied may include: In every B first time domain resource sets, the b^{th} (b may be one or more numbers) first time domain resource set may be a first time domain resource set which a first resource mapping pattern indicated by the third information is applied to or takes effect on.

It should be noted that according to the second information or the third information, the terminal may determine, based on the first resource mapping pattern, the time domain resource used for backscatter communication from within one or more first time domain resource sets. For example, the terminal may determine, based on the first resource mapping pattern, the time domain resource used for backscatter communication from within one first time domain resource set. Alternatively, the terminal may determine, based on the first resource mapping pattern, time domain resources used for backscatter communication from within all of the subsequent first time domain resource sets. Alternatively, the terminal may determine, based on the first resource mapping pattern, the time domain resource used for backscatter communication from within Wx first time domain resource sets. Herein, Wx is an integer greater than 0. Wx may be configured by a network, or may be a preset value. For example, Wx may be configured by using the second information or the third information.

### Embodiment 2

In Embodiment 2, first information may be dynamically configured by a network device. In other words, a time domain resource used by a terminal to perform backscatter communication may be dynamically scheduled by the network device by using the first information.

The first information may be used to indicate a first resource mapping pattern. In a target time domain resource set, the first resource mapping pattern may be used for configuring, for the terminal, the time domain resource used for backscatter communication.

A method for determining a target time domain resource set is not limited in this application.

In an implementation, the target time domain resource set is a first time domain resource set that bears the first information, or the target time domain resource set includes a first time domain resource set that bears the first information and one or more first time domain resource sets that are located after the first time domain resource set that bears the first information. In other words, starting from the first time domain resource set in which the first information is received, the terminal determines, based on the first information, the time domain resource used for backscatter communication.

The first time domain resource set in which the first information is received may be a first time domain resource set to which a basic time domain unit in which the terminal receives the first information belongs. The basic time domain unit in which the terminal receives the first information may be any basic time domain unit in the first time domain resource set. For the first time domain resource set in which the first information is received, the terminal may determine, based on the first information, whether all or some basic time domain units in this first time domain resource set can be used for backscatter communication. For example, for the first time domain resource set in which the first information is received the terminal may start from the basic time domain unit in which the first information is received or from the x^{th} basic time domain unit after the basic time domain unit in which the first information is received, and determine, based on the first information, a backscatter communication resource. Herein, x may be an integer greater than 0.

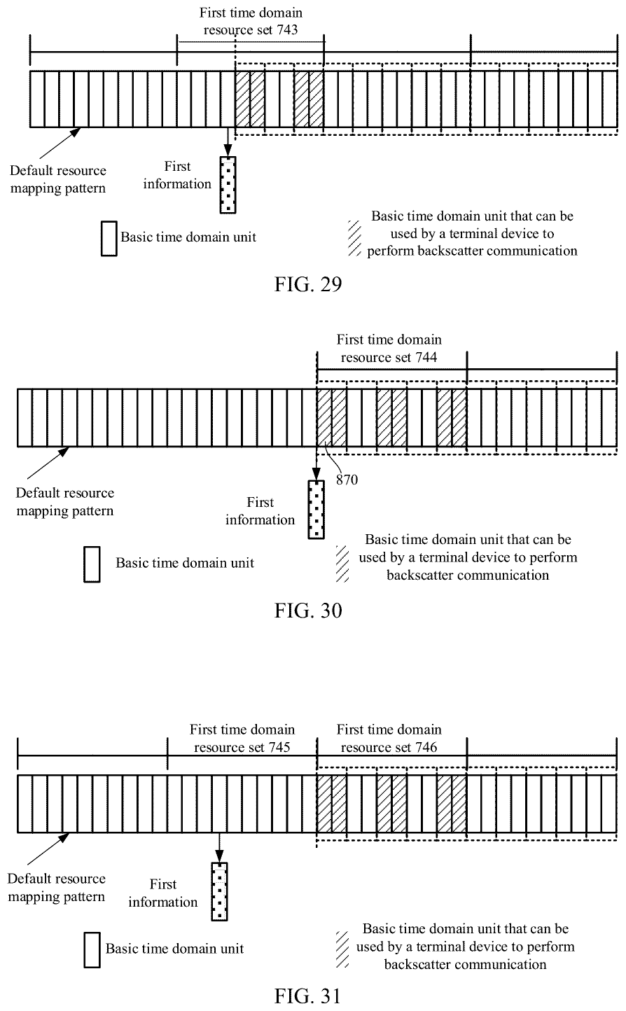

FIG. 29 is a diagram of an example of a first time domain resource set according to an embodiment of this application. In FIG. 29, the first time domain resource set in which the first information is received is a first time domain resource set 743. Starting from the first time domain resource set 743, the terminal may determine, based on the first information, the time domain resource used for backscatter communication.

In an implementation, the target time domain resource set includes one or more first time domain resource sets, the 1^{st} basic time domain unit in the earliest first time domain resource set in the target time domain resource set is an eighth basic time domain unit, and the eighth basic time domain unit is used for bearing the first information. In other words, starting from the eighth basic time domain unit, the terminal may determine, based on the first information, the time domain resource used for backscatter communication. The eighth basic time domain unit is a basic time domain unit in which the first information is received, and the eighth basic time domain unit is the 1^{st} basic time domain unit in the first time domain resource set. It may be understood that in this implementation, the terminal may use the eighth basic time domain unit as the 1^{st} basic time domain unit in one first time domain unit set, to determine a start location of the first time domain resource set.

FIG. 30 is a diagram of an example of a first time domain resource set according to an embodiment of this application. In FIG. 30, the basic time domain unit in which the first information is received is a second basic time domain unit 870. The second time domain unit 870 may be the 1^{st} basic time domain unit in a first time domain resource set 744. Starting from the first time domain resource set 744, the terminal may determine, based on the first information, the time domain resource used for backscatter communication.

In some implementations, the target time domain resource set is the T^{th} first time domain resource set after a first time domain resource set that bears the first information, or the target time domain resource set includes the T^{th} first time domain resource set and one or more first time domain resource sets that are located after the T^{th} first time domain resource set. In other words, starting from the T^{th} first time domain resource set after the first information is received, the terminal may determine, based on the first information, the time domain resource used for backscatter communication. Herein, T is an integer greater than or equal to 0. Optionally, T may be configured by the network device, or T may be a preset value. For example, T may be configured by using the first information. Alternatively, T may be configured by using other information configured by the network device. It may be understood that, when T=0, the T^{th} first time domain resource set after the first information is received is the next first time domain resource set after the first information is received. In a case that T=0, the T^{th} first time domain resource set is a first time domain resource set next to the first time domain resource set in which the first information is received.

FIG. 31 is a diagram of an example of a first time domain resource set according to an embodiment of this application. In FIG. 31, the first time domain resource set in which the terminal receives the first information is a first time domain resource set 745. A first time domain resource set next to the first time domain resource set 745 is a first time domain resource set 746. Starting from the first time domain resource 746, the terminal may determine, based on an indication of the first information, the time domain resource used for backscatter communication.

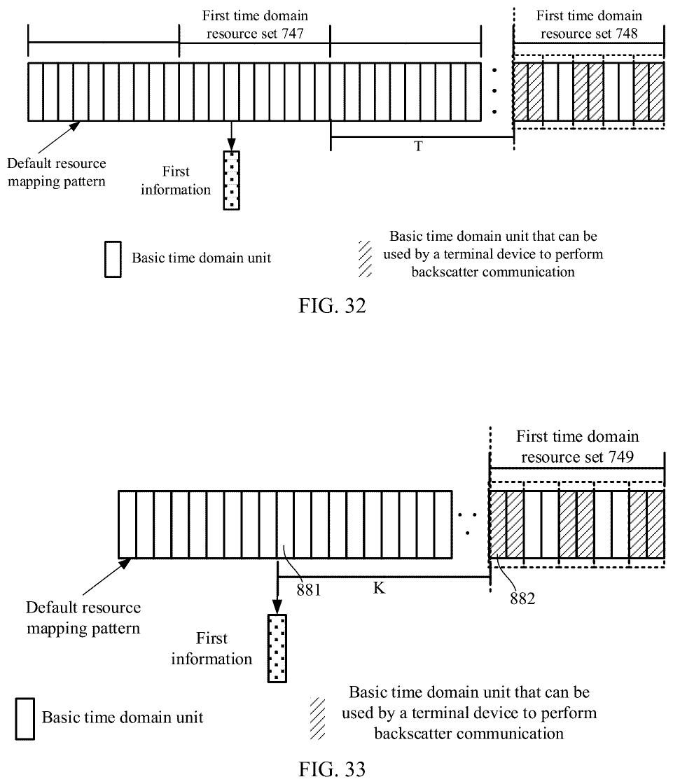

FIG. 32 is a diagram of an example of a first time domain resource set according to an embodiment of this application. In FIG. 32, the first time domain resource set in which the terminal receives the first information is a first time domain resource set 747. The T^{th} first time domain resource set after the first time domain resource set 747 is a first time domain resource set 748. Starting from the first time domain resource set 748, the terminal may determine, based on the first information, the time domain resource used for backscatter communication.

In some implementations, the target time domain resource set includes one or more first time domain resource sets, the 1^{st} basic time domain unit in the earliest first time domain resource set in the target time domain resource set is a ninth basic time domain unit, and the ninth basic time domain unit is the Kth basic time domain unit after an eighth basic time domain unit that bears the first information. In other words, starting from the ninth basic time domain unit, the terminal may determine, based on the first information, the time domain resource used for backscatter communication. The ninth basic time domain unit is the Kth basic time domain unit after the first information is received, and the ninth basic time domain unit is the 1^{st} basic time domain unit in the first time domain resource set, where K is an integer greater than or equal to 0. Optionally, K may be configured by the network device, or K may be a preset value. For example, K may be configured by using third information. Alternatively, K may be configured by using other information configured by the network device. In a case that K=0, the Kth basic time domain unit is a first basic time domain unit next to the basic time domain unit in which the first information is received.

FIG. 33 is a diagram of an example of a first time domain resource set according to an embodiment of this application. In FIG. 33, the terminal receives the first information in a basic time domain unit 881. The Kth basic time domain unit after the first information is received is a ninth basic time domain unit 882. The ninth time domain unit 882 may be the 1^{st} basic time domain resource in a first time domain resource set 749. Starting from the first time domain resource set 749, the terminal may determine, based on the first information, the time domain resource used for backscatter communication.

In an implementation, when the terminal determines, based on the first information, the time domain resource used for backscatter communication, for a first time domain resource set that meets a third rule, the terminal may determine, based on a first resource mapping pattern indicated by the first information, the time domain resource used for backscatter communication. The third rule may include a feature of the first time domain resource set to which the first resource mapping pattern is applied. In other words, the third rule may be used to indicate one or more first time domain resource sets associated with the first resource mapping pattern. The terminal may not determine, based on the first information, the time domain resource used for backscatter communication for a first time domain resource set that does not meet the third rule. For example, the terminal may determine, based on a default resource mapping pattern, the time domain resource used for backscatter communication for the first time domain resource set that does not meet the third rule. Alternatively, the terminal may not determine, based on the first information, the time domain resource used for backscatter communication for a first time domain resource set that does not meet the third rule. For example, the feature, included in the third rule, of the first time domain resource set to which the first resource mapping pattern is applied may include: In every C first time domain resource sets, the c^{th} (c may be one or more numbers) first time domain resource set may be a first time domain resource set which a first resource mapping pattern indicated by the first information is applied to or takes effect on.

It should be noted that a manner (semi-static configuration manner or dynamic configuration manner) for determining a backscatter communication resource may be controlled by using a resource mapping method which is semi-statically configured. For example, an enable switch of “determining a backscatter communication resource based on a dynamically scheduled resource mapping bit” may be semi-statically configured. When the enable switch is configured as being enabled, the time domain resource used for backscattering may be determined in a dynamic configuration manner. When the enable switch is configured as being disabled, the time domain resource used for backscattering may be determined in a semi-static configuration manner. Alternatively, a manner of determining the time domain resource used for backscattering may be configured semi-statically. For example, in a case that a backscatter communication resource is determined based on a dynamically scheduled resource mapping bit, backscatterResourcetype0 may be configured; or in a case that a backscatter communication resource is determined based on a semi-statically configured resource mapping bit, backscatterResourcetype1 may be configured.

It should be noted that Embodiment 1 and Embodiment 2 may be separately implemented or may be implemented in combination. For example, when control information dynamically indicated by the network device includes a resource mapping bit for a first resource mapping pattern, a backscatter communication resource in the first time domain resource set may be determined based on the resource mapping bit in the dynamically indicated control information. When there is no resource mapping bit in the control information dynamically indicated by the network device, the terminal device may determine the backscatter communication resource in the first time domain resource set based on a semi-statically configured resource mapping pattern. When there is no resource mapping bit in the first resource mapping pattern in the dynamically indicated control information, a plurality of semi-statically configured resource mapping patterns may be carried, for example, an identifier of the first resource mapping pattern, to further determine a resource mapping pattern that is specifically used and semi-statically configured, thereby determining the backscatter communication resource in the first time domain resource set.

It should be noted that the first resource mapping pattern may be used to indicate the time domain resource, in the one or more first time domain resource sets, that can be determined by the terminal to perform backscatter communication. The terminal may determine the first resource mapping pattern based on the first information, the second information, or the third information; and determine, based on the first resource mapping pattern, the time domain resource used for backscatter communication.

In an implementation, the first resource mapping pattern may be continuously used for a plurality of first time domain resource sets. In other words, before switching to another resource mapping pattern, the terminal may determine, based on configuration of the first resource mapping pattern, the resource used for backscatter communication. FIG. 13 to FIG. 20 and FIG. 24 to FIG. 28 each are a diagram of an example in which a first resource mapping pattern is used to continuously indicate a time domain resource in a plurality of first time domain resource sets that can be used by a terminal to determine a time domain resource for performing backscatter communication.

In another implementation, the first resource mapping pattern is used for configuring, for the terminal, the time domain resource used for backscatter communication in W first time domain resource sets, where W is an integer greater than 0. W may be configured by a network device. Alternatively, W may be a preset value.

In a case that W=1, the first resource mapping pattern may be used to indicate a time domain resource, in one first time domain resource set, that can be used for the terminal to perform backscatter communication. FIG. 29 to FIG. 33 each are a diagram of an example in which a first resource mapping pattern is used to indicate a time domain resource, in one first time domain resource set, that can be used for a terminal to perform backscatter communication.

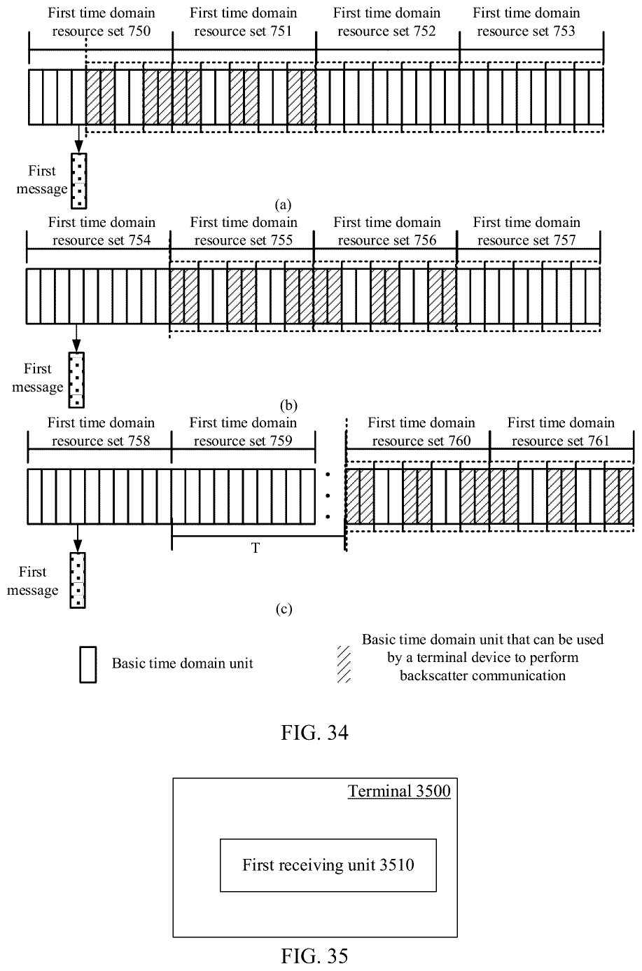

In a case that W>1, the first resource mapping pattern may indicate time domain resources used for backscatter communication in a plurality of first time domain resource sets. FIG. 34 (a), FIG. 34 (b), and FIG. 34 (c) each are a diagram of an example in which W is equal to 2 in a case that there is different effective time for a first resource mapping pattern.

It should be noted that the terminal may determine, based on a default resource mapping pattern, the time domain resource used for backscatter communication from outside the target time domain resource set determined based on the first information, the second information, or the third information. The default resource mapping pattern may be preset, or may be one or more resource mapping patterns from at least one semi-statically configured resource mapping pattern.

The foregoing describes method embodiments of this application in detail with reference to FIG. 5 to FIG. 34. The following describes apparatus embodiments of this application in detail with reference to FIG. 35 to FIG. 37. It should be understood that the descriptions of the method embodiments correspond to descriptions of the apparatus embodiments. Therefore, for parts that are not described in detail, refer to the foregoing method embodiments.

FIG. 35 is a schematic diagram of a structure of a terminal 3500 according to an embodiment of this application. The terminal 3500 may include a first receiving unit 3510.

The first receiving unit 3510 is configured to receive first information sent by a network device. The first information is used for configuring, for the terminal, a time domain resource used for backscatter communication.

Optionally, the first information is used to indicate a first resource mapping pattern, and the first resource mapping pattern is used for configuring, for the terminal, the time domain resource used for backscatter communication.

Optionally, the time domain resource used for backscatter communication belongs to at least one first time domain resource set.

Optionally, the first resource mapping pattern includes M resource mapping bits, the first time domain resource set includes N basic time domain units, and the M resource mapping bits are associated with the N basic time domain units. Herein, M is an integer greater than 0, and Nis an integer greater than 0.

Optionally, the M resource mapping bits include a first resource mapping bit, the N basic time domain units include a first basic time domain unit, and the first resource mapping bit is associated with the first basic time domain unit. In a case that the first resource mapping bit is a first bit value, the first basic time domain unit is used for backscatter communication; or in a case that the first resource mapping bit is a second bit value, the first basic time domain unit is not used for backscatter communication.

Optionally, in a case that M is equal to N, the M resource mapping bits are in one-to-one association with the N basic time domain units.

Optionally, in a case that M is greater than N, N resource mapping bits in the M resource mapping bits are in one-to-one association with the N basic time domain units.

Optionally, first N consecutive resource mapping bits in the M resource mapping bits are in one-to-one association with the N basic time domain units; or final N consecutive resource mapping bits in the M resource mapping bits are in one-to-one association with the N basic time domain units.

Optionally, in a case that M is less than N, the first resource mapping pattern includes a first resource mapping bit; and the first resource mapping bit is associated with G or N−(M−1)×G basic time domain units in the first time domain resource set, where G is an integer greater than 0.

Optionally, each of first M−1 resource mapping bits in the first time domain resource set is associated with the G basic time domain units, and a final resource mapping bit in the first time domain resource set is associated with the N−(M−1)×G basic time domain units; or the 1^{st} resource mapping bit in the first time domain resource set is associated with the N−(M−1)×G basic time domain units, and each of final M−1 resource mapping bits in the first time domain resource set is associated with the G basic time domain units.

Optionally, in a case that M×G=N, each of M resource mapping bits in a first time domain resource is associated with the G basic time domain units.

Optionally, G is configured by the network device, or G is a preset value.

Optionally, G is obtained through calculation based on M and/or N.

Optionally, G satisfies G=┌N/M┐, G= └N/M┘, or G=N/M.

Optionally, M satisfies M=┌N/G┐, M=└N/G┘, or M=N/G.

Optionally, a quantity of bits of resource mapping bits in the first resource mapping pattern is a fixed value, or a quantity of bits of resource mapping bits in the first resource mapping pattern is an unfixed value.

Optionally, the first information is semi-statically configured by the network device, the first information is used to indicate a candidate resource mapping pattern, and the candidate resource mapping pattern includes the first resource mapping pattern.

Optionally, the candidate resource mapping pattern includes a second resource mapping pattern, the first resource mapping pattern includes a first resource mapping bit, the second resource mapping pattern includes a second resource mapping bit, a quantity of units of basic time domain units associated with the first resource mapping bit is a first quantity, a quantity of units of basic time domain units associated with the second resource mapping bit is a second quantity, and the first quantity and the second quantity are not equal.

Optionally, the candidate resource mapping pattern includes a second resource mapping pattern, a quantity of bits of resource mapping bits in the first resource mapping pattern is a first quantity of bits, a quantity of bits of resource mapping bits in the second resource mapping pattern is a second quantity of bits, and the first quantity of bits and the second quantity of bits are not equal.

Optionally, the terminal 3500 is further configured to: determine, by the terminal based on the first information, the time domain resource used for backscatter communication from within a target time domain resource set. The target time domain resource set is a first time domain resource set that bears the first information; or the target time domain resource set includes a first time domain resource set that bears the first information and one or more first time domain resource sets that are located after the first time domain resource set that bears the first information.

Optionally, the terminal 3500 is further configured to: determine, by the terminal based on the first information, the time domain resource used for backscatter communication from within a target time domain resource set. The target time domain resource set is the Lth first time domain resource set after a first time domain resource set that bears the first information, or the target time domain resource set includes the Lth first time domain resource set and one or more first time domain resource sets that are located after the Lth first time domain resource set, where L is an integer greater than or equal to 0.

Optionally, L is configured by the network device, or L is a preset value.

Optionally, the terminal 3500 is further configured to: determine, by the terminal based on the first information, the time domain resource used for backscatter communication from within a target time domain resource set. The target time domain resource set includes one or more first time domain resource sets, the 1^{st} basic time domain unit in the earliest first time domain resource set in the target time domain resource set is a second basic time domain unit, and the second basic time domain unit is used for bearing the first information.

Optionally, the terminal 3500 is further configured to: determine, by the terminal based on the first information, the time domain resource used for backscatter communication from within a target time domain resource set. The target time domain resource set includes one or more first time domain resource sets, the 1^{st} basic time domain unit in the earliest first time domain resource set in the target time domain resource set is a third basic time domain unit, and the third basic time domain unit is the U^{th} basic time domain unit after the second basic time domain unit that bears the first information, where U is an integer greater than or equal to 0.

Optionally, U is configured by the network device, or U is a preset value.

Optionally, the terminal 3500 further includes: a second receiving unit, configured to receive second information sent by the network device. The second information is used for instructing the terminal to determine, based on the first information, the time domain resource used for backscatter communication from within a target time domain resource set.

Optionally, the target time domain resource set is a first time domain resource set that bears the second information; or the target time domain resource set includes a first time domain resource set that bears the second information and one or more first time domain resource sets that are located after the first time domain resource set that bears the first information.

Optionally, the target time domain resource set is the V^{th} first time domain resource set after a first time domain resource set that bears the second information, or the target time domain resource set includes the V^{th} first time domain resource set and one or more first time domain resource sets that are located after the V^{th} first time domain resource set, where Vis an integer greater than or equal to 0.

Optionally, V is configured by the network device, or Vis a preset value.

Optionally, the target time domain resource set includes one or more first time domain resource sets, the 1^{st} basic time domain unit in the earliest first time domain resource set in the target time domain resource set is a fourth basic time domain unit, and the fourth basic time domain unit is used for bearing the second information.

Optionally, the target time domain resource set includes one or more first time domain resource sets, the 1^{st} basic time domain unit in the earliest first time domain resource set in the target time domain resource set is a fifth basic time domain unit, and the fifth basic time domain unit is the p^{th} basic time domain unit after a fourth basic time domain unit that bears the second information, where P is an integer greater than or equal to 0.

Optionally, P is configured by the network device, or P is a preset value.

Optionally, the candidate resource mapping pattern includes a plurality of resource mapping patterns, the plurality of resource mapping patterns include at least two periodic resource mapping patterns, and the at least two periodic resource mapping patterns are used for alternately configuring, in one period for the terminal, the time domain resource used for backscatter communication.

Optionally, that the terminal determines, based on the first information, the time domain resource used for backscatter communication includes that the terminal determines, based on the first information, the time domain resource used for backscatter communication from within a first time domain resource set that meets a first rule.

Optionally, the terminal 3500 further includes: a third receiving unit, configured to receive third information sent by the network device, where the third information is used to indicate the first resource mapping pattern in the candidate resource mapping pattern; and a determining unit, configured to determine, based on the first resource mapping pattern, the time domain resource used for backscatter communication.

Optionally, the third information includes identification information of the first resource mapping pattern.

Optionally, the terminal 3500 is further configured to: determine, by the terminal based on the third information, the time domain resource used for backscatter communication from within a target time domain resource set. The target time domain resource set is a first time domain resource set that bears the third information; or the target time domain resource set includes a first time domain resource set that bears the third information and one or more first time domain resource sets that are located after the first time domain resource set that bears the third information.

Optionally, the terminal 3500 is further configured to: determine, by the terminal based on the third information, the time domain resource used for backscatter communication from within a target time domain resource set. The target time domain resource set is the Q^{th} first time domain resource set after a first time domain resource set that bears the third information, or the target time domain resource set includes the Q^{th} first time domain resource set and one or more first time domain resource sets that are located after the Q^{th} first time domain resource set, where Q is an integer greater than or equal to 0.

Optionally, Q is configured by the network device, or Q is a preset value.

Optionally, the terminal 3500 is further configured to: determine, by the terminal based on the third information, the time domain resource used for backscatter communication from within a target time domain resource set. The target time domain resource set includes one or more first time domain resource sets, the 1^{st} basic time domain unit in the earliest first time domain resource set in the target time domain resource set is a sixth basic time domain unit, and the sixth basic time domain unit is used for bearing the third information.

Optionally, the terminal is further configured to: determine, by the terminal based on the third information, the time domain resource used for backscatter communication from within a target time domain resource set. The target time domain resource set includes one or more first time domain resource sets, the 1^{st} basic time domain unit in the earliest first time domain resource set in the target time domain resource set is a seventh basic time domain unit, and the seventh basic time domain unit is the R^{th} basic time domain unit after a sixth basic time domain unit that bears the third information, where R is an integer greater than or equal to 0.

Optionally, R is configured by the network device, or R is a preset value.

Optionally, that the terminal determines, based on the third information, the time domain resource used for backscatter communication includes that the terminal determines, based on the first resource mapping pattern, the time domain resource used for backscatter communication from within a first time domain resource set that meets a second rule.

Optionally, the time domain resource used for backscatter communication is dynamically scheduled by the network device by using the first information.

Optionally, the terminal 3500 is further configured to: determine, by the terminal based on the first information, the time domain resource used for backscatter communication from within a target time domain resource set. The target time domain resource set is a first time domain resource set that bears the first information; or the target time domain resource set includes a first time domain resource set that bears the first information and one or more first time domain resource sets that are located after the first time domain resource set that bears the first information.

Optionally, the terminal 3500 is further configured to: determine, by the terminal based on the first information, the time domain resource used for backscatter communication from within a target time domain resource set. The target time domain resource set is the T^{th} first time domain resource set after a first time domain resource set that bears the first information, or the target time domain resource set includes the T^{th} first time domain resource set and one or more first time domain resource sets that are located after the T^{th} first time domain resource set, where T is an integer greater than or equal to 0.

Optionally, T is configured by the network device, or Tis a preset value.

Optionally, the terminal 3500 is further configured to: determine, by the terminal based on the first information, the time domain resource used for backscatter communication from within a target time domain resource set. The target time domain resource set includes one or more first time domain resource sets, the 1^{st} basic time domain unit in the earliest first time domain resource set in the target time domain resource set is an eighth basic time domain unit, and the eighth basic time domain unit is used for bearing the first information.

Optionally, the terminal 3500 is further configured to: determine, by the terminal based on the first information, the time domain resource used for backscatter communication from within a target time domain resource set. The target time domain resource set includes one or more first time domain resource sets, the 1^{st} basic time domain unit in the earliest first time domain resource set in the target time domain resource set is a ninth basic time domain unit, and the ninth basic time domain unit is the Kth basic time domain unit after an eighth basic time domain unit that bears the first information, where K is an integer greater than or equal to 0.

Optionally, K is configured by the network device, or K is a preset value.

Optionally, that the terminal determines, based on the first information, the time domain resource used for backscatter communication includes that the terminal determines, based on the first resource mapping pattern, the time domain resource used for backscatter communication from within a first time domain resource set that meets a third rule.

Optionally, the first resource mapping pattern is used for configuring, for the terminal, the time domain resource used for backscatter communication in W first time domain resource sets, where W is an integer greater than 0.

Optionally, W is configured by the network device, or W is a preset value.

Optionally, the terminal 3500 further includes: determining, by the terminal based on a default resource mapping pattern, the time domain resource used for backscatter communication from outside the target time domain resource set.

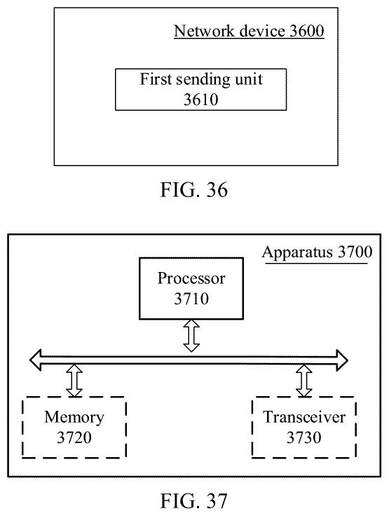

Optionally, the terminal 3500 is further configured to perform backscatter communication by using some or all of time domain resources configured by using the first information. FIG. 36 is a schematic diagram of a structure of a network device 3600 according to an embodiment of this application. The network device 3600 may include a first sending unit 3610.

The first sending unit 3610 is configured to send first information to a terminal. The first information is used for configuring, for the terminal, a time domain resource used for backscatter communication.

Optionally, the first information is used to indicate a first resource mapping pattern, and the first resource mapping pattern is used for configuring, for the terminal, the time domain resource used for backscatter communication.

Optionally, the time domain resource used for backscatter communication belongs to at least one first time domain resource set.

Optionally, the first resource mapping pattern includes M resource mapping bits, the first time domain resource set includes N basic time domain units, and the M resource mapping bits are associated with the N basic time domain units. Herein, Mis an integer greater than 0, and Nis an integer greater than 0.

Optionally, the M resource mapping bits include a first resource mapping bit, the N basic time domain units include a first basic time domain unit, and the first resource mapping bit is associated with the first basic time domain unit. In a case that the first resource mapping bit is a first bit value, the first basic time domain unit is used for backscatter communication; or in a case that the first resource mapping bit is a second bit value, the first basic time domain unit is not used for backscatter communication.

Optionally, in a case that M is equal to N, the M resource mapping bits are in one-to-one association with the N basic time domain units.

Optionally, in a case that M is greater than N, N resource mapping bits in the M resource mapping bits are in one-to-one association with the N basic time domain units.

Optionally, first N consecutive resource mapping bits in the M resource mapping bits are in one-to-one association with the N basic time domain units; or final N consecutive resource mapping bits in the M resource mapping bits are in one-to-one association with the N basic time domain units.

Optionally, in a case that M is less than N, the first resource mapping pattern includes a first resource mapping bit; and the first resource mapping bit is associated with G or N−(M−1)×G basic time domain units in the first time domain resource set, where G is an integer greater than 0.

Optionally, in a case that M×G=N, each of M resource mapping bits in a first time domain resource is associated with the G basic time domain units.

Optionally, each of first M−1 resource mapping bits in the first time domain resource set is associated with the G basic time domain units, and a final resource mapping bit in the first time domain resource set is associated with the N−(M−1)×G basic time domain units; or the 1^{st} resource mapping bit in the first time domain resource set is associated with the N−(M−1)×G basic time domain units, and each of final M−1 resource mapping bits in the first time domain resource set is associated with the G basic time domain units.

Optionally, G is configured by the network device, or G is a preset value.

Optionally, G is obtained through calculation based on M and/or N.

Optionally, G satisfies G=┌N/M┐, └G=N/M┘, or G=N/M.

Optionally, M satisfies M=┌N/G┐, └M=N/G┘, or M=N/G,

Optionally, a quantity of bits of resource mapping bits in the first resource mapping pattern is a fixed value, or a quantity of bits of resource mapping bits in the first resource mapping pattern is an unfixed value.

Optionally, the first information is semi-statically configured by the network device, the first information is used to indicate a candidate resource mapping pattern, and the candidate resource mapping pattern includes the first resource mapping pattern.

Optionally, the candidate resource mapping pattern includes a second resource mapping pattern, the first resource mapping pattern includes a first resource mapping bit, the second resource mapping pattern includes a second resource mapping bit, a quantity of units of basic time domain units associated with the first resource mapping bit is a first quantity, a quantity of units of basic time domain units associated with the second resource mapping bit is a second quantity, and the first quantity and the second quantity are not equal.

Optionally, the candidate resource mapping pattern includes a second resource mapping pattern, a quantity of bits of resource mapping bits in the first resource mapping pattern is a first quantity of bits, a quantity of bits of resource mapping bits in the second resource mapping pattern is a second quantity of bits, and the first quantity of bits and the second quantity of bits are not equal.

Optionally, the network device 3600 is further configured to configure L, where L is used for instructing the terminal to determine, based on the first information, the time domain resource used for backscatter communication from within a target time domain resource set. The target time domain resource set is the Lth first time domain resource set after a first time domain resource set that bears the first information, or the target time domain resource set includes the Lth first time domain resource set and one or more first time domain resource sets that are located after the Lth first time domain resource set, where L is an integer greater than or equal to 0.

Optionally, the network device 3600 is further configured to configure U, where U is used for instructing the terminal to determine, based on the first information, the time domain resource used for backscatter communication from within a target time domain resource set. The target time domain resource set includes one or more first time domain resource sets, the 1^{st} basic time domain unit in the earliest first time domain resource set in the target time domain resource set is a third basic time domain unit, and the third basic time domain unit is the U^{th} basic time domain unit after a second basic time domain unit that bears the first information, where U is an integer greater than or equal to 0.

Optionally, the network device 3600 further includes: a second sending unit, configured to send second information to the terminal device. The second information is used for instructing the terminal to determine, based on the first information, the time domain resource used for backscatter communication from within a target time domain resource set. Optionally, the network device 3600 is further configured to configure V, where V is an integer greater than or equal to 0. The target time domain resource set is the V^{th} first time domain resource set after a first time domain resource set that bears the second information, or the target time domain resource set includes the V^{th} first time domain resource set and one or more first time domain resource sets that are located after the V^{th} first time domain resource set.

Optionally, the network device 3600 is further configured to configure P, where P is an integer greater than or equal to 0. The target time domain resource set includes one or more first time domain resource sets, the 1^{st} basic time domain unit in the earliest first time domain resource set in the target time domain resource set is a fifth basic time domain unit, and the fifth basic time domain unit is the P^{th} basic time domain unit after a fourth basic time domain unit that bears the second information.

Optionally, the first information is used to indicate a plurality of resource mapping patterns, the plurality of resource mapping patterns include at least two periodic resource mapping patterns, and that the terminal determines, based on the first information, the time domain resource used for backscatter communication includes that the terminal periodically determines, based on the at least two periodic resource mapping patterns, the time domain resource used for backscatter communication within one period.

Optionally, that the terminal determines, based on the first information, the time domain resource used for backscatter communication includes that the terminal determines, based on the first information, the time domain resource used for backscatter communication from within a first time domain resource set that meets a first rule.

Optionally, the network device 3600 further includes: a third sending unit, configured to send third information to the terminal. The third information is used for instructing the terminal to determine, based on the first resource mapping pattern in the candidate resource mapping pattern indicated by the first information, the time domain resource used for backscatter communication.

Optionally, the third information includes identification information of the first resource mapping pattern.

Optionally, the network device 3600 is further configured to configure Q, where Q is used for instructing the terminal to determine, based on the third information, the time domain resource used for backscatter communication from within a target time domain resource set. The target time domain resource set is the Q^{th} first time domain resource set after a first time domain resource set that bears the third information, or the target time domain resource set includes the Q^{th} first time domain resource set and one or more first time domain resource sets that are located after the Q^{th} first time domain resource set, where Q is an integer greater than or equal to 0.

Optionally, the network device 3600 is further configured to configure R, where R is used for instructing the terminal to determine, based on the third information, the time domain resource used for backscatter communication from within a target time domain resource set. The target time domain resource set includes one or more first time domain resource sets, the 1^{st} basic time domain unit in the earliest first time domain resource set in the target time domain resource set is a seventh basic time domain unit, and the seventh basic time domain unit is the R^{th} basic time domain unit after a sixth basic time domain unit that bears the third information, where R is an integer greater than or equal to 0.

Optionally, that the terminal determines, based on the third information, the time domain resource used for backscatter communication includes that the terminal determines, based on the first resource mapping pattern, the time domain resource used for backscatter communication from within a first time domain resource set that meets a second rule.

Optionally, the time domain resource used for backscatter communication is dynamically scheduled by the network device by using the first information.

Optionally, the network device 3600 is further configured to configure T, where T is used for instructing the terminal to determine, based on the first information, the time domain resource used for backscatter communication from within a target time domain resource set. The target time domain resource set is the T^{th} first time domain resource set after a first time domain resource set that bears the first information, or the target time domain resource set includes the T^{th} first time domain resource set and one or more first time domain resource sets that are located after the T^{th} first time domain resource set, where T is an integer greater than or equal to 0.

Optionally, the network device 3600 is further configured to configure K, where K is used for instructing the terminal to determine, based on the first information, the time domain resource used for backscatter communication from within a target time domain resource set. The target time domain resource set includes one or more first time domain resource sets, the 1^{st} basic time domain unit in the earliest first time domain resource set in the target time domain resource set is a ninth basic time domain unit, and the ninth basic time domain unit is the Kth basic time domain unit after an eighth basic time domain unit that bears the first information, where K is an integer greater than or equal to 0.

Optionally, that the terminal determines, based on the first information, the time domain resource used for backscatter communication includes that the terminal determines, based on the first resource mapping pattern, the time domain resource used for backscatter communication from within a first time domain resource set that meets a third rule.

Optionally, the first resource mapping pattern is used for configuring, for the terminal, the time domain resource used for backscatter communication in W first time domain resource sets, where W is an integer greater than 0.

Optionally, W is configured by the network device, or W is a preset value.

FIG. 37 is a schematic diagram of a structure of a communications apparatus according to an embodiment of this application. Dashed lines in FIG. 37 indicate that units or modules are optional. The apparatus 3700 may be configured to implement the methods described in the foregoing method embodiments. The apparatus 3700 may be a chip, a terminal device, or a network device.

The apparatus 3700 may include one or more processors 3710. The processor 3710 may support the apparatus 3700 in implementing the methods described in the foregoing method embodiments. The processor 3710 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 3700 may further include one or more memories 3720. The memory 3720 stores a program thereon. The program may be executed by the processor 3710, so that the processor 3710 performs the methods described in the foregoing method embodiments. The memory 3720 may be separate from the processor 3710 or may be integrated into the processor 3710.

The apparatus 3700 may further include a transceiver 3730. The processor 3710 may communicate with another device or chip through the transceiver 3730. For example, the processor 3710 may send and receive data to and from another device or chip through the transceiver 3730.

An embodiment of this application further provides a computer-readable storage medium for storing a program. The computer-readable storage medium may be applied to the terminal or the network device provided in embodiments of this application, and the program causes a computer to perform the methods performed by the terminal or the network device in various embodiments of this application.

An embodiment of this application further provides a computer program product.

The computer program product includes a program. The computer program product may be applied to the terminal or the network device provided in embodiments of this application, and the program causes a computer to perform the methods performed by the terminal or the network device in various embodiments of this application.

An embodiment of this application further provides a computer program. The computer program may be applied to the terminal or the network device provided in embodiments of this application, and the computer program causes a computer to perform the methods performed by the terminal or the network device in various embodiments of this application.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the specification, claims, and drawings of this application are used for distinguishing different objects from each other, rather than defining a specific order. In addition, the terms “include” and “have” and any variations thereof are intended to cover a non-exclusive inclusion.

The “indication” mentioned in embodiments of this application may be a direct indication or an indirect indication, or indicate an association relationship. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association between A and B.

In embodiments of this application, “B corresponding to A” means that B is associated with A, and B may be determined based on A. However, it should be further understood that determining B based on A does not mean determining B based on only A, but instead B may be determined based on A and/or other information.

In embodiments of this application, the term “corresponding” may mean that there is a direct or indirect correspondence between two elements, or that there is an association relationship between two elements, or that there is a relationship of “indicating” and “being indicated”, “configuring” and “being configured”, or the like.

In embodiments of this application, “predefining” or “preconfiguring” can be implemented by prestoring corresponding code or a corresponding table in a device (for example, including a terminal device and a network device) or in other manners that can be used for indicating related information. A specific implementation thereof is not limited in this application. For example, predefining may indicate being defined in a protocol.

In embodiments of this application, the “protocol” may indicate a standard protocol in the communication field, which may include, for example, an LTE protocol, an NR protocol, and a related protocol applied to a future communications system. This is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in this specification usually indicates an “or” relationship between the associated objects.

In embodiments of this application, sequence numbers of the foregoing processes do not mean execution orders. The execution orders of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between apparatuses or units may be implemented in electronic, mechanical, or other forms.

The units described as separate parts may or may not be physically separate, and parts displayed as units may or may not be physical units, and may be at one location, or may be distributed on a plurality of network elements. Some or all of the units may be selected according to actual requirements to achieve the objectives of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on the computer, all or some procedures or functions in embodiments of this application are generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

1. A method for configuring resources, comprising:
receiving, by a terminal, first information sent by a network device, wherein the first information is used for configuring, for the terminal, a time domain resource used for backscatter communication.

2. The method according to claim 1, wherein the first information is used to indicate a first resource mapping pattern, and the first resource mapping pattern is used for configuring, for the terminal, the time domain resource used for backscatter communication.

3. The method according to claim 2, wherein the time domain resource used for backscatter communication belongs to at least one first time domain resource set,
wherein the first resource mapping pattern comprises M resource mapping bits, the first time domain resource set comprises N basic time domain units, and the M resource mapping bits are associated with the N basic time domain units, wherein M is an integer greater than 0, and N is an integer greater than 0, and
wherein the first information is semi-statically configured by the network device, the first information is used to indicate a candidate resource mapping pattern, and the candidate resource mapping pattern comprises the first resource mapping pattern.

4. The method according to claim 3, wherein the method further comprises:
determining, by the terminal based on the first information, the time domain resource used for backscatter communication from within a target time domain resource set, wherein
the target time domain resource set comprises one or more first time domain resource sets, the 1^{st} basic time domain unit in the earliest first time domain resource set in the target time domain resource set is a third basic time domain unit, and the third basic time domain unit is the U^{th} basic time domain unit after a second basic time domain unit that bears the first information, wherein U is an integer greater than or equal to 0.

5. The method according to claim 3, wherein the method further comprises:
receiving, by the terminal, second information sent by the network device, wherein the second information is used for instructing the terminal to determine, based on the first information, the time domain resource used for backscatter communication from within a target time domain resource set.

6. The method according to claim 5, wherein the target time domain resource set comprises one or more first time domain resource sets, the 1^{st} basic time domain unit in the earliest first time domain resource set in the target time domain resource set is a fifth basic time domain unit, and the fifth basic time domain unit is the p^{th} basic time domain unit after a fourth basic time domain unit that bears the second information, wherein P is an integer greater than or equal to 0.

7. The method according to claim 1, wherein the method further comprises:
performing, by the terminal, backscatter communication by using some or all of the time domain resources configured by using the first information.

8. A terminal, comprising a processor and a memory, wherein the memory is configured to store a computer program, and the processor is configured to invoke and run the computer program stored in the memory to cause the terminal to perform:
receiving first information sent by a network device, wherein the first information is used for configuring, for the terminal, a time domain resource used for backscatter communication.

9. The terminal according to claim 8, wherein the first information is used to indicate a first resource mapping pattern, and the first resource mapping pattern is used for configuring, for the terminal, the time domain resource used for backscatter communication.

10. The terminal according to claim 9, wherein the time domain resource used for backscatter communication belongs to at least one first time domain resource set,
wherein the first resource mapping pattern comprises M resource mapping bits, the first time domain resource set comprises N basic time domain units, and the M resource mapping bits are associated with the N basic time domain units, wherein M is an integer greater than 0, and N is an integer greater than 0, and
wherein the first information is semi-statically configured by the network device, the first information is used to indicate a candidate resource mapping pattern, and the candidate resource mapping pattern comprises the first resource mapping pattern.

11. The terminal according to claim 10, wherein the candidate resource mapping pattern comprises a plurality of resource mapping patterns, the plurality of resource mapping patterns comprise at least two periodic resource mapping patterns, and the at least two periodic resource mapping patterns are used for alternately configuring, in one period for the terminal, the time domain resource used for backscatter communication.

12. The terminal according to claim 10, wherein the processor is further configured to invoke and run the computer program stored in the memory to cause the terminal to perform:
receiving third information sent by the network device, wherein the third information is used to indicate the first resource mapping pattern in the candidate resource mapping pattern; and
determining, based on the first resource mapping pattern, the time domain resource used for backscatter communication.

13. The terminal according to claim 12, wherein the third information comprises identification information of the first resource mapping pattern.

14. The terminal according to claim 9, wherein the time domain resource used for backscatter communication belongs to at least one first time domain resource set,
wherein the first resource mapping pattern comprises M resource mapping bits, the first time domain resource set comprises N basic time domain units, and the M resource mapping bits are associated with the N basic time domain units, wherein M is an integer greater than 0, and N is an integer greater than 0, and
wherein the time domain resource used for backscatter communication is dynamically scheduled by the network device by using the first information.

15. A network device, comprising a processor and a memory, wherein the memory is configured to store a computer program, and the processor is configured to invoke and run the computer program stored in the memory to cause the network device to perform:
sending first information to a terminal, wherein the first information is used for configuring, for the terminal, a time domain resource used for backscatter communication.

16. The network device according to claim 15, wherein the first information is used to indicate a first resource mapping pattern, and the first resource mapping pattern is used for configuring, for the terminal, the time domain resource used for backscatter communication.

17. The network device according to claim 16, wherein the time domain resource used for backscatter communication belongs to at least one first time domain resource set,
wherein the first resource mapping pattern comprises M resource mapping bits, the first time domain resource set comprises N basic time domain units, and the M resource mapping bits are associated with the N basic time domain units, wherein M is an integer greater than 0, and N is an integer greater than 0, and
wherein the first information is semi-statically configured by the network device, the first information is used to indicate a candidate resource mapping pattern, and the candidate resource mapping pattern comprises the first resource mapping pattern.

18. The network device according to claim 17, wherein the processor is further configured to invoke and run the computer program stored in the memory to cause the network device to perform:
configuring U, wherein U is used for instructing the terminal to determine, based on the first information, the time domain resource used for backscatter communication from within a target time domain resource set, wherein
the target time domain resource set comprises one or more first time domain resource sets, the 1^{st} basic time domain unit in the earliest first time domain resource set in the target time domain resource set is a third basic time domain unit, and the third basic time domain unit is the U^{th} basic time domain unit after a second basic time domain unit that bears the first information, wherein U is an integer greater than or equal to 0.

19. The network device according to claim 17, wherein the processor is further configured to invoke and run the computer program stored in the memory to cause the network device to perform:
sending second information to the terminal device, wherein the second information is used for instructing the terminal to determine, based on the first information, the time domain resource used for backscatter communication from within a target time domain resource set.

20. The network device according to claim 19, wherein the processor is further configured to invoke and run the computer program stored in the memory to cause the network device to perform:
configuring P, wherein P is an integer greater than or equal to 0, the target time domain resource set comprises one or more first time domain resource sets, the 1^{st} basic time domain unit in the earliest first time domain resource set in the target time domain resource set is a fifth basic time domain unit, and the fifth basic time domain unit is the P^{th} basic time domain unit after a fourth basic time domain unit that bears the second information.
